(19) United States
(12) Patent Application Publication
(10) Pub. No.: US 2026/0161738 A1
(43) Pub. Date: Jun. 11, 2026

(54) COMPUTING ARCHITECTURE FOR COMPONENT-LEVEL PROGRESSION ASSESSMENT IN COMPOSITE ENTITIES

(71) Applicant: Generation Lab Inc., San Francisco, CA (US)

(72) Inventors: Rui SU, San Francisco, CA (US); Michael SUSWAL, San Francisco, CA (US); Runting HAN, Jinan (CN); Aidan S. TAI, Menlo Park, CA (US)

(21) Appl. No.: 19/390,421

(22) Filed: Nov. 14, 2025

Related U.S. Application Data
(60) Provisional application No. 63/729,267, filed on Dec. 6, 2024.

(51) Int. Cl. G06F 18/2113; G06F 18/21; G06F 18/22; G06F 123/02; G06N 20/00

(52) U.S. Cl. CPC G06F 18/2113; G06F 18/217; G06F 18/22; G06N 20/00; G06F 2123/02

(57) ABSTRACT

A system analyzes the temporal progression of individual components within a composite entity. The computing system receives discrete time series of multi-dimensional feature vectors collected from the composite entity. For each component, a distinct subset of features is identified using variability analysis, enabling differentiation between components. Longitudinal changes in these feature subsets are analyzed over the time series to generate component-specific temporal progression profiles. A user interface enables display and exploration of these profiles, supporting visualization of progression trends for selected components of the composite entity.

### CROSS-REFERENCE TO RELATED APPLICATION(S)

This application claims benefit to U.S. Provisional Application 63/729,267, filed on Dec. 6, 2024, which is incorporated herein in its entirety for all purposes.

### TECHNICAL FIELD

This disclosure relates to a computerized system that analyzes and quantifies the temporal progression of individual components within composite entities by processing discrete time series of multi-dimensional feature data.

### BACKGROUND

The assessment and quantification of temporal progression within complex systems comprising multiple interrelated components pose significant technical challenges. In domains where such systems generate large volumes of heterogeneous feature data over time, reliably identifying which markers or variables are indicative of meaningful component-level progression is difficult due to dynamic variability and the interplay of numerous factors. Conventional approaches frequently rely on statistically adjusting data to fit model curves, often without sufficient physical or operational justification, resulting in predictions that lack robustness and are prone to overfitting.

Additionally, existing methods struggle to process and analyze datasets efficiently. Integrating information from diverse sources and component types, harmonizing formats, and maintaining scalable performance remain unresolved obstacles in many data-driven systems. Predictive modeling in these contexts can be hampered by overfitting, limiting the reliability of insights and forecasts. Furthermore, translating complex analytical results into actionable guidance for end-users requires advanced filtering, ranking, and visualization mechanisms to support informed decision-making.

### SUMMARY

In some embodiments, the disclosure described herein relate to a system for analyzing component-specific progressions of a composite entity, the system including: a computing system including memory and one or more processors, the memory storing code instructions, wherein the code instructions, when executed by the one or more processors, cause the one or more processors to: receive discrete time series of feature vectors, each feature vector including multi-dimensional features measured from the composite entity at a discrete time, the composite entity including a plurality of components; identify, for a first component of the plurality of components in the composite entity, a first subset of the features that are determined to be associated with the first component based on a variability analysis, wherein the first subset of the features corresponding to the first component is different from a second subset of the features corresponding to a second component in the composite entity; analyze longitudinal variations of the first subset of the features over the time series, wherein the longitudinal variations include alterations of values of the first subset of features; and generate a component-specific temporal progression profile of the first component based on analyzing the longitudinal variations; and a user interface in communication with computing system, wherein the user interface is configured to display component-specific temporal progression profiles of at least a subset of components in the composite entity.

In some embodiments, the disclosure described herein relate to a computer-implemented method for analyzing component-specific progressions of a composite entity, the computer-implemented method including: receiving discrete time series of feature vectors, each feature vector including multi-dimensional features measured from the composite entity at a discrete time, the composite entity including a plurality of components; identifying, for a first component of the plurality of components in the composite entity, a first subset of the features that are determined to be associated with the first component based on a variability analysis, wherein the first subset of the features corresponding to the first component is different from a second subset of the features corresponding to a second component in the composite entity; analyzing longitudinal variations of the first subset of the features over the time series, wherein the longitudinal variations include alterations of values of the first subset of features; and generating a component-specific temporal progression profile of the first component based on analyzing the longitudinal variations; and causing to display, at a user interface, component-specific temporal progression profiles of at least a subset of components in the composite entity.

In some embodiments, the disclosure described herein relate to a non-transitory computer-readable medium configured to store code including instructions for analyzing component-specific progressions of a composite entity, wherein the instructions, when executed by one or more processors, cause the one or more processors to: receive discrete time series of feature vectors, each feature vector including multi-dimensional features measured from the composite entity at a discrete time, the composite entity including a plurality of components; identify, for a first component of the plurality of components in the composite entity, a first subset of the features that are determined to be associated with the first component based on a variability analysis, wherein the first subset of the features corresponding to the first component is different from a second subset of the features corresponding to a second component in the composite entity; analyze longitudinal variations of the first subset of the features over the time series, wherein the longitudinal variations include alterations of values of the first subset of features; and generate a component-specific temporal progression profile of the first component based on analyzing the longitudinal variations; and cause to display, at a user interface, component-specific temporal progression profiles of at least a subset of components in the composite entity.

### BRIEF DESCRIPTION OF THE DRAWINGS

Figure (FIG. 1 is a block diagram illustrating a system diagram of an entropy analysis and recommendation environment, in accordance with some embodiments.

FIG. 2 is a block diagram illustrating an entropy analysis system, in accordance with some embodiments.

FIG. 3 is a block diagram illustrating an example epigenetic recommendation pipeline, in accordance with some embodiments.

FIG. 4 is a block diagram illustrating a pipeline for identifying key entropy sites, in accordance with some embodiments.

FIG. 5A is a block diagram illustrating a functional organ analysis that includes specific analyses used to analyze functional organ using entropy data, in accordance with some embodiments.

FIG. 5B is a flowchart depicting an example process for performing a functional analysis of a complex self-regulating system, in accordance with some embodiments.

FIG. 6A is a conceptual diagram illustrating an example graphical user interface that displays information of organ-specific ages generated by the entropy analysis system, in accordance with some embodiments.

FIG. 6B is a conceptual diagram illustrating an example graphical user interface that displays information of organ-specific ages generated by the entropy analysis system, in accordance with some embodiments.

FIG. 6C is a conceptual diagram illustrating an example graphical user interface that displays information aging trajectory and insights that are generated by the entropy analysis system, in accordance with some embodiments.

FIG. 7 is a flowchart depicting a process for generating personalized epigenetic based recommendation, in accordance with some embodiments.

FIG. 8 illustrates an example graphical user interface, which displays personalized epigenetic recommendations generated by the entropy analysis system, in accordance with some embodiments.

FIG. 9 is a flowchart depicting an example process for performing a component specific analysis of a composite entity, in accordance with some embodiments.

FIG. 10 is a conceptual diagram illustrating a structure of an example neural network, in accordance with some embodiments.

FIG. 11 is a block diagram illustrating components of an example computing machine, in accordance with some embodiments.

The figures depict, and the detailed description describes, various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

The disclosed computerized system provides a robust framework for analyzing the temporal progression of individual components within composite entities, such as complex machinery or biological systems. By receiving discrete time series of multi-dimensional feature vectors, the system separates key subsets of features relevant to specific components through sophisticated variability analyses. This allows for differentiation between components and targeted tracking of changes over time. Advanced models, including machine learning algorithms, may be applied to these feature subsets to reveal significant longitudinal variations, assess progression rates, and generate predictive component-specific profiles. These analytical capabilities can support applications ranging from industrial maintenance, tracking operational metrics of machinery parts, to biological settings such as monitoring organ-specific aging trajectories.

An integrated user interface further enhances the utility of the system by visualizing component-specific progression profiles, enabling users to interact with data, compare trends, and receive actionable insights. The system can be extended with features that include ranking features by predictive power, segmentation of data into phases or events, and generation of personalized recommendations for configuration or operational modifications. Its flexible architecture allows the inclusion of reference population data, external sources, and normative benchmarks, making it adaptable to diverse use cases. Together, these capabilities provide a comprehensive solution for monitoring, analyzing, and optimizing the functional status of complex, multi-component entities over time.

The disclosed computerized system introduces technical solutions for analyzing the temporal progression of individual components within composite entities, addressing several core data handling and processing challenges. Through the use of advanced data library architectures, the system efficiently organizes and indexes multi-dimensional time series feature vectors, enabling rapid access to relevant data without the need to store redundant or overly granular records. Batch processing and targeted feature selection algorithms further minimize the storage footprint by only retaining features and data subsets statistically relevant to specific components and progression analysis.

Additionally, the system implements novel marker selection pipelines and machine learning models that reduce system complexity. These models allow for dynamic grouping and ranking of features using variability analysis and unsupervised clustering, streamlining predictive analytics without requiring extensive computational resources. Integrated feedback mechanisms and adaptive retraining ensure the analytical algorithms remain efficient and accurate over time, further optimizing memory and processor usage. Collectively, these technical improvements not only enhance the scalability and reliability of the overall architecture, but also present concrete advantages in system efficiency that go beyond abstract data manipulation or mere automation.

### System Overview

Referring now to Figure (FIG. 1, shown is a block diagram illustrating an embodiment of an example system environment 100 for entropy analysis, in accordance with some embodiments. By way of example, the system environment 100 includes a computing system 110, a point-of-care device 120, a sample analyzer 125, a client device 130, and a data store 140. The entities and components in the system environment 100 may communicate with each other through network 150. In various embodiments, the system environment 100 may include fewer or additional components. The system environment 100 also may include different components.

The components in the system environment 100 may each correspond to a separate and independent entity or may be controlled by the same entity. For example, in some embodiments, the computing system 110 and an application 132 are operated by the same entity. In some embodiments, the computing system 110 provides a point-of-care device 120 to a user that controls a client device 130.

While each of the components in this disclosure is sometimes described in disclosure in a singular form, the system environment 100 and elsewhere in this disclosure may include one or more of each of the components. For example, there can be multiple client devices 130 that are in communication with the computing system 110. While a component may at times be described in this disclosure in a singular form, it should be understood that, in various embodiments, the component may have multiple instances. Likewise, while some of the components are described in a plural form, in some embodiments each of those components may have only a single instance in the system environment 100.

In some embodiments, the computing system 110 is a computing system that analyzes sample data of a target complex self-regulating system, such as a target individual's body. The computing system 110 may provide analyses to the target system's temporal progression such as the aging process of an individual. The computing system 110 may also be referred to as an epigenetic analysis system, an entropy analysis system. The data analyzed may include various biological data such as DNA methylation, RNA sequencing, PCR, and proteomic data. The system 110 receives one or more samples of the individual and identifies key entropy markers that are correlated to a system's temporal progression.

For example, a target system's progression may refer to the aging process of an individual. The entropy markers may be any biological markers that may be relevant to the aging process, such as CpG sites, DNA methylation patterns, gene expression levels, telomere length, mitochondrial DNA mutations, histone modifications, microRNA profiles, DNA repair efficiency, protein folding patterns, oxidative stress indicators, lipid peroxidation levels, metabolic rate markers, inflammatory cytokine levels, autophagy-related proteins, cellular senescence markers, reactive oxygen species (ROS) levels, glycomic and other suitable markers of dysregulation of RNA, DNA, proteins, or metabolites. The entropy data may take various forms, such as CpG methylation data, proteomics data, transcriptomic data, genomic data, metabolomics data, epigenomic data, lipidomics data, microbiome data, gene expression data, histone modification data, chromatin accessibility data, single-cell RNA sequencing data, exosome content data, immune profiling data, and cellular morphology data. In some embodiments, the entropy markers may also be referred to as epigenetic markers.

In some embodiments, the computing system 110 may focus on the entropy markers of CpG sites for methylation analysis. The key CpG sites are identified as being associated with aging processes and health conditions. In some embodiments, the CpG sites can also be organ-specific and the computing system 110 can determine the organ-specific aging process. In some embodiments, the selected CpG sites may correspond to genes that regulate the maintenance, function, and/or repair of an organ. The CpG sites may be related to gene expression, but may also be related to other gene signals such as gene silencing, repression of transcriptional activity, chromatin condensation, inhibitory signaling, suppression of gene activation, downregulation of cellular pathways, epigenetic inactivation, prevention of protein synthesis, and transcriptional blockage.

In some embodiments, the entropy marker datasets analyzed by the computing system 110 may encompass a wide range of sizes, depending on application scope and analytical depth. Targeted panels could include hundreds to several thousand CpG sites, such as the over 1,000 probes used in certain aging-related assays, while more comprehensive studies may scale to tens of thousands of CpG sites. On a genome-wide scale, advanced methylation analysis platforms or chips can process up to approximately 270,000 CpG sites or more per sample. When these high-dimensional markers are collected longitudinally across multiple time points and large population cohorts, the resulting dataset size may grow to millions of individual data points. Each data entry can capture multi-dimensional features such as methylation levels, gene expression profiles, and other omic measurements for each CpG site, per individual, and per time point. The mathematical and computational complexity of extracting trends, variability, and meaningful associations from such massive, multi-modal data arrays far exceeds what can be performed through manual inspection or mental processes. Accordingly, the processing and analysis of these extensive datasets demand robust, sophisticated computational infrastructure, which cannot be performed manually or mentally.

After sample data are processed, the computing system 110 generates analyses that reflect the cell ages of different organismal systems and provides recommendations such as diet and exercise recommendations and health interventions based on the user's epigenetic profile. In some embodiments, the computing system 110 may continuously update the analysis as new samples are received, offering periodically updated insights into a user's health. For example, the computing system 110 may analyze the values of the panel of entropy markers over a period of time and display the cell age of the individual based on the values of the panel of entropy markers.

In some embodiments, the computing system 110 may generate personalized recommendations based on the user's entropy data. The entropy data may be referred to as epigenetic data such as the user's CpG methylation data. The computing system 110 may utilize a health scoring function to assess the user's health status, which may be derived from the methylation patterns at specific CpG sites across various organismal systems. In response to the health status being determined, computing system 110 may incorporate environmental and lifestyle data, such as dietary habits, physical activity, sleep patterns, exposure to pollutants, and other user data that is authorized by the user, to model the potential impact of these factors on the user's health trajectory. In some embodiments, the computing system 110 then a recommendation algorithm that analyzes how changes in these environmental and lifestyle metrics may influence the user's biological markers, such as reversing certain signs of aging or improving organ function.

In some embodiments, computing system 110 may continuously track updates in both the user's biological data and environmental metrics. In turn, the computing system 110 refines the recommendations to the user over time. By way of example, if the computing system 110 detects a significant improvement in the user's methylation patterns related to bone health after increased vitamin D intake, the computing system 110 may further recommend continued or modified vitamin D supplementation to Omega3 supplement. Similarly, if the computing system 110 identifies detrimental changes in cardiovascular markers linked to sedentary behavior, the computing system 110 may suggest an increase in physical activity tailored to the user's lifestyle. This dynamic feedback loop allows the computing system 110 to provide actionable, real-time recommendations that evolve with the user's ongoing health data.

In some embodiments, the computing system 110 may include multiple components such as data storage, processing units, and algorithms for analyzing large datasets. The datasets may be obtained from public sources, clinical trials, or proprietary collections to allow the computing system 110 to make personalized health recommendations. The computing system 110 may integrate new biomarkers and evolving algorithms. In some embodiments, the computing system 110 supports integration with third-party applications, such as fitness trackers or health apps, enabling users to receive ongoing feedback and health recommendations through various platforms based on their entropy data.

In various embodiments, the computing system 110 may take different suitable forms. For example, while the computing system 110 is described in a singular form, the computing system 110 may include one or more computers that operate independently, cooperatively, and/or distributively. In various embodiments, the computing system 110 may be a single server or a distributed system of servers that function collaboratively. In some embodiments, the computing system 110 may be implemented as a cloud-based service, a local server, or a hybrid system that powers computing system 110 in both local and cloud environments. In some embodiments, the computing system 110 may be a server computer that includes one or more processors and memory that stores code instructions that are executed by one or more processors to perform various processes described herein. In some embodiments, the computing system 110 may also be referred to as a computing device or a computing server. In some embodiments, the computing system 110 may be a pool of computing devices that may be located at the same geographical location (e.g., a server room) or be distributed geographically (e.g., cloud computing, distributed computing, or in a virtual server network). In some embodiments, the computing system 110 may be a collection of servers that independently, cooperatively, and/or distributively provide various products and services described in this disclosure. The computing system 110 may also include one or more virtualization instances such as a container, a virtual machine, a virtual private server, a virtual kernel, or another suitable virtualization instance.

In some embodiments, a point-of-care device 120 is a device that is used by a user to interact with the user, such as by collecting biological samples of the user. A point-of-care device 120 may operate at a point-of-care location, such as the user's home, a caretaking facility, a clinic, a medical care facility, a fitness center, a workplace location, etc. For example, a point-of-care device 120 may collect and analyze biological samples at regular intervals directly from the user's home or other care environments. A point-of-care device 120 may collect samples for monitoring various biomarkers such as by collecting samples such as hair, saliva, blood, or other biological fluids. In some embodiments, a point-of-care device 120 may be designed for convenience and may provide immediate feedback or transmit the data to the computing system 110 for more comprehensive analysis. In some instances, the point-of-care device 120 may be connected to a broader health monitoring network, such as a network operated by the computing system 110. The point-of-care device 120 may send the collected data to healthcare providers or a personalized recommendation system for real-time updates on the user's health profile, such as aging metrics and organ function analysis.

In some embodiments, a point-of-care device 120 may be a kit with components for taking a biological sample. For example, the kit could contain a swab or other blood sample collecting device. The kit may also include a container into which the swab/collection device is placed. This container could be a holder for the swab/collection device to avoid contamination. The container could also be a tube or well that holds buffer or one or more reagents into which the swab is placed to deposit sample. One or more components of the kit, such as the container holder, the sample collecting device or the tube or well holding the deposited sample, may be used locally by the user to perform an analysis on the sample or may be mailed by the user to a laboratory that conducts the analysis on the sample. In some embodiments, the kit may include a registration manual with QR code connecting to the user registration portal of computing system 110. In some embodiments, the kit may include a non-invasive biological samples blood/saliva collection device, a biohazard bag with sample collection tube including reagents, a bag including alcohol wipes, lancets, bandage, medical grade Gauze Pad, a preprinted shipping bag with shipping label attached. In some embodiments, the kit may be probe based and include probes for detection of targeted entropy markers (e.g., CpG sites) that are determined by the various processes that are discussed in this disclosure. In some embodiments, the kit may include PCR primers that target various entropy markers.

In various embodiments, a point-of-care device 120 may take different physical forms to suit various user preferences and needs. For example, a point-of-care device 120 may be integrated into everyday household items such as a toothbrush that automatically collects saliva samples during routine use. Other possible form factors include a tabletop assay analyzer that fits easily within a home and performs daily analysis of biological samples, or a wearable device, such as a wristband, which collects sweat or skin samples. Another form factor may be a smart patch that adheres to the skin, passively collecting data and transmitting the data wirelessly to the computing system 110. In some embodiments, the point-of-care device 120 may also be a sample collection device that is designed for the collection of a particular type of biological sample, such as a cheek swab.

In some embodiments, the computing system 110 may operate a subscription model wherein users periodically submit biological samples for analysis. The computing system 110 may receive these samples at regular intervals, such as monthly or quarterly, and analyze a panel of entropy markers, such as DNA methylation at specific CpG sites. Over time, the computing system 110 tracks changes in the user's biological markers and calculates the user's cell age. The subscription model allows the system to generate a continuous stream of data, updating the user's health profile with each new sample. This data may then be used to display updated cell age values and provide personalized recommendations, such as dietary, lifestyle, or therapeutic interventions, through application 132. The recurring nature of the subscription allows users to receive ongoing insights into the users' health, monitor the users' biological aging process, and make informed decisions regarding the users' wellness.

In some embodiments, the subscription model may also integrate with external platforms to allow users to receive services such as personalized meal plans, supplement deliveries, or fitness regimens based on the users' latest entropy data. The computing system 110 may also facilitate real-time health tracking by storing users' longitudinal data in a secure backend, enabling the continuous refinement of health recommendations. This dynamic approach to monitoring and improving health creates a personalized experience that evolves in line with the user's biological data over time.

While in this disclosure examples are given for computing system 110 to provide a recurring sample-collection plan to a user to track cell ages and changes for the user, in various embodiments the features described herein, such as functional organ analyses may also be applied in non-recurring (e.g., one time) uses. For example, a user may choose to provide a sample for the functional organ analyses at a particular occasion, but the user may not be a subscriber.

In some embodiments, a sample analyzer 125 may be used to analyze biological samples provided by the user. The type of samples that can be processed by the sample analyzer 125 may vary depending on the embodiments. For example, the types of samples may include blood, saliva, or other tissue, to extract relevant biological data such as DNA, RNA, or protein information. This data is then used to perform analyses, such as biological assays, PCR, microarray, DNA sequencing, RNA sequencing, or methylation analysis, depending on the types of data used by the computing system 110. The results from the sample analyzer 125 may be used to determine the biological age of the user, assess organ and systems function, or evaluate the efficacy of health interventions based on changes in entropy markers over time.

In some embodiments, various types of sample analyzers 125 may correspond to different types of sequencing devices, such as DNA sequencers or methylation-specific sequencers. A sample analyzer 125 may be integrated into a point-of-care device 120, allowing for rapid analysis of the samples in a user's home or a clinical setting. In some embodiments, a sample analyzer 125 may be a laboratory or professional-grade device that operates outside of the point-of-care system. A sample analyzer 125 may use advanced technologies, such as massively parallel sequencing, including any next-generation sequencing (NGS), methylation sequencing, and other high-throughput sequencing techniques. A sample analyzer 125 may generate data that provides a detailed and comprehensive analysis of entropy markers across large panels of CpG sites or entire genomes. In such cases, the biological samples collected at the point of care may be sent to a specialized laboratory where these high-throughput sequencing techniques are employed. The data generated from these advanced sequencing processes is then integrated into the computing system 110, providing users with in-depth insights into their epigenetic profile, cell age, and personalized health recommendations based on more extensive and precise analysis. For example, the sample analyzer 125 may analyze a DNA methylation chip with a total of 270K CpG sites, including the 460 aging related epigenetic CpG sites. In some embodiments, the sample analyzer 125 may analyze a multiplex PCR panel with 460 core CpG sites representing biological noise measurement in human aging.

The type of analysis generated by a sample analyzer 125 may depend on embodiments. A sample analyzer 125 may perform DNA methylation assays, such as bisulfite sequencing, which identify methylation patterns at CpG sites, as well as RNA sequencing (RNA-seq) for transcriptomic profiling that captures gene expression levels. Proteomic assays, such as mass spectrometry or enzyme-linked immunosorbent assays (ELISA), may also be generated to analyze protein levels and modifications. Additionally, whole-genome sequencing (WGS) and whole-exome sequencing (WES) may be utilized to provide comprehensive genetic information, while chromatin immunoprecipitation sequencing (ChIP-seq) may be employed to study DNA-protein interactions. Assays that measure other entropy markers, such as histone modifications or non-coding RNA levels, may also be generated. A sample analyzer 125 may also perform polymerase chain reaction (PCR) assays used for specific gene amplification, and flow cytometry assays to assess cellular phenotypes. Depending on embodiments where different types of data that the computing system 110 uses, the computing system 110 may combine biological datasets to provide a holistic view of the biological state of the user to enable precise health interventions based on multi-omic data.

In some embodiments, a client device 130 may serve as an interface for the user to interact with the computing system 110. The client device 130 is used to display information such as the user's current biological age, as calculated from the entropy data, detailed insights into the aging process of specific organs, such as cardiovascular or immune systems, and other information such as results of DNA methylation, RNA sequencing, and proteomic analyses. Users may access time series data regarding their biological age, organ function, and personalized health recommendations based on these analyses. The device 130 may also allow users to track their health over time by receiving continuous updates from the system as they submit new biological samples, enhancing their ability to make informed health decisions.

In some embodiments, a client device 130 may be any electronic device capable of processing and displaying data. These devices may include, but are not limited to, personal computers, laptops, smartphones, tablet devices, or smartwatches. In other instances, the client device 130 may be part of wearable technology or integrated into home health systems. Some embodiments may also support multiple devices, allowing the user to access the computing system 110 from different locations. The device may utilize secure communication protocols to maintain the confidentiality of the user's health data during analysis and display. In some embodiments, a client device 130 may also be referred to as a user device. A client device 130 may be controlled by a user.

In some embodiments, an application 132 is a software application that serves as a client-facing frontend for the computing system 110. Application 132 can be configured to display personalized health insights and recommendations based on the user's entropy data. The application 132 may also provide entropy data illustration, such as a time series of changes related to biological markers such as DNA methylation at CpG sites. The application 132 may, such as under a subscription model, continuously update the user's health profile by analyzing recurring biological samples collected via the point-of-care device 120 to generate time series feedback.

In some embodiments, a client device 130 may include multiple applications 132 that are operated by different entities but are integrated to provide recommendations to a user based on entropy data and other use data. For example, the application 132 provided by the computing system 110 can integrate with third-party platforms, allowing users to receive health-related suggestions, such as dietary, food, meal choices or exercise plans tailored to their current health condition. For instance, users may receive recommendations on meal plans or supplements to improve organ-specific health based on epigenetic methylation patterns observed in the users' biological samples. Examples of integrations include food/meal delivery apps or fitness tracking systems that offer customized meal and exercise plans. The application 132 may also be linked to other wellness services, such as personalized vitamin and supplement recommendations, based on the user's epigenetic profile. Other possible implementations may include partnerships with healthcare providers or fitness experts to offer targeted wellness plans and interventions based on real-time data collected through the app.

In some embodiments, an application 132 may take the form of a universal interface or a universal application. In some embodiments, instead of having multiple applications 132, a client device 130 may use a single universal application that integrates multiple applications into a single cohesive platform. The universal application may serve as an all-in-one hub that allows users to access various functionalities, such as messaging, social media, reservation, itinerary planning, fitness tracking, banking, payment, entertaining, and epigenetic profile management, through a unified interface. Instead of switching between separate applications 132, the universal application 132 aggregates data and features from individual applications, including the entropy data managed by the computing system 110, and makes recommendations to a user in a seamless experience. The universal application may use AI-driven recommendation and task automation to reduce the clutter of multiple applications to provide a more efficient, user-friendly experience.

By way of example, a universal application may integrate entropy data and cell age information for various organs into users' day-to-day activities, providing personalized health and wellness recommendations. By aggregating entropy data, such as DNA methylation markers and biological age for specific organs, the universal application can offer tailored suggestions on diet, exercise, and lifestyle modifications that align with the user's health status. For instance, if the system detects signs of accelerated aging in the cardiovascular system, the app might recommend heart-healthy dietary changes, such as increasing omega-3 intake from food or reducing salt consumption. The universal application may also synchronize with other health-related apps and services, such as meal delivery platforms, fitness trackers, or meditation apps, to create a holistic wellness plan. Based on the user's epigenetic profile, the universal application might suggest specific meals from a partnered service that optimizes nutritional needs or recommend yoga sessions to improve stress management if stress-related aging is detected. Furthermore, the universal application could track the recommendations' effectiveness over time by monitoring updated biological samples and cell ages, refining future suggestions based on how the user responds. This integration of entropy data into daily routines would empower users to make proactive, science-backed decisions that improve the users' long-term health and wellness.

While some of the integration features are described in the setting of multiple independent applications 132 while other integration features are described in the setting of a universal application, in various embodiments the examples described in this disclosure may be used in any types of settings of application 132.

In some embodiments, a user interface 134 may be the interface of the application 132 and allow the user to perform various actions associated with application 132. For example, application 132 may be a software application, and the user interface 134 may be the front end. The user interface 134 may take different forms. In some embodiments, the user interface 134 is a graphical user interface (GUI) of a software application. For example, the computing system 110 may provide system 1 age information for various organs and may cause the user interface 134 to display graphical illustrations of the information. In some embodiments, the front-end software application 132 is a software application that can be downloaded and installed on a client device 130 via, for example, an application store (App store) of the client device 130. In some embodiments, the front-end software application 132 takes the form of a webpage interface that allows users to perform actions through web browsers. A front-end software application includes a GUI 134 that displays various information and graphical elements. In some embodiments, the GUI may be the web interface of a software-as-a-service (SaaS) platform that is rendered by a web browser. In some embodiments, user interface 134 does not include graphical elements but communicates with a server or a node via other suitable ways, such as command windows or application program interfaces (APIs).

One or more data stores 140 may be used to store various data used in the system environment 100, such as entropy data, biological age markers, methylation patterns at CpG sites, health recommendations, user profiles, environmental and lifestyle metrics, historical sample data, and treatment efficacy results. One or more data stores 140 may also store user-specific health insights, algorithm training data, and analytics used for generating personalized health interventions based on epigenetic profiling. In some embodiments, one or more data stores 140 may store information from third-party integrations, such as dietary logs or fitness activity data, used to refine recommendations. In some embodiments, one or more data stores 140 may also store sequencing data generated from DNA methylation analyses or other types of genomic and transcriptomic sequencing. This sequencing data may include detailed information about the user's CpG sites, RNA sequences, proteomic profiles, and any genetic variations identified through epigenetic testing, including data generated by a point-of-care device 120 or a sample analyzer 125. Additionally, the data store may hold large datasets related to longitudinal sequencing results, which track changes in the user's biological markers over time.

A data store 140 includes one or more storage units, such as memory, that take the form of a non-transitory and non-volatile computer storage medium to store various data. The computer-readable storage medium is a medium that does not include a transitory medium, such as a propagating signal or a carrier wave. In one embodiment, the data store 140 communicates with other components by a network 150. This type of data store 140 may be referred to as a cloud storage server. Examples of cloud storage service providers may include AMAZON AWS, DROPBOX, RACKSPACE CLOUD FILES, AZURE, GOOGLE CLOUD STORAGE, etc. In some embodiments, instead of a cloud storage server, a data store 140 may be a storage device that is controlled and connected to a server, such as the computing system 110. For example, the data store 140 may take the form of memory (e.g., hard drives, flash memory, discs, ROMs, etc.) used by the server, such as storage devices in a storage server room that is operated by the server. The data store 140 might also support various data storage architectures, including block storage, object storage, or file storage systems. Additionally, it may include features like redundancy, data replication, and automated backup to ensure data integrity and availability. A data store 140 can be a database, data warehouse, data lake, etc.

The communications among the computing system 110, a point-of-care device 120, a sample analyzer 125, a client device 130, an application 132, and a data store 140 may be transmitted via a network 150. In some situations, a network 150 may be a local network. In some situations, a network 150 may be a public network such as the Internet. In one embodiment, the network 150 uses standard communications technologies and/or protocols. Thus, the network 150 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 150 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 150 can be represented using technologies and/or formats, including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 150 also includes links and packet-switching networks such as the Internet.

Various embodiments described herein relate to methods and systems for assessing entropy status that indicates the temporal health status of a complex self-regulating system. A complex self-regulating system may be a biological system or biophysical or biochemical system such as the body of an individual, or a cell, or a tissue, or organ, or interconnected organs, with self-regulation mechanisms such as gene expression, or metabolic processes, or signal transduction. The entropy analysis may reveal the temporal progression (e.g., system age) of the individual and function specific temporal progression (e.g., organ specific age).

By way of example, an entropy analysis system may determine biological aging, increased risk of diseases, and organ function through entropy analysis such as epigenetic profiling, specifically focusing on biological markers of entropy such as DNA methylation at CpG sites. CpG is shorthand for 5′-C-phosphate-G-3′, which refers to a cytosine nucleotide and guanine nucleotide in DNA that is separated by a phosphate group. CpG sites (also called CG sites) are regions of DNA where a cytosine nucleotide is followed by a guanine nucleotide in a linear sequence of bases that runs in the 5′ to 3′ direction. CpG islands are genomic regions where CpG sites occur with high frequency in genomic regions. In various embodiments, other entropy markers such as any data related to dysregulation of CpGs, RNA, DNA, proteins, or metabolites can be used.

An entropy analysis system may select significant entropy markers that correlate with aging by analyzing changes in methylation patterns across a broad age range. The entropy analysis system may perform functional organ analysis to determine the biological age of various organs, using statistical models to track methylation changes and understand dynamics of entropy (its increase/decrease with time) within specific systems such as cardiovascular, immune, regeneration, etc.

Based on entropy data such as DNA methylation data, the entropy analysis system provides personalized recommendations for health interventions tailored to the user's unique epigenetic profile. These recommendations include dietary changes, supplements, and lifestyle adjustments designed to diminish the entropy, thereby improving the health of specific organismal functions and slow the overall process of entropy accumulation, i.e., tissue aging. The entropy analysis system continuously updates its recommendations as new data is collected, ensuring that the guidance remains relevant over time. By integrating data from external sources and allowing for real-time tracking through third-party apps, the entropy analysis system offers a comprehensive, dynamic approach to attenuate the increase of entropy, i.e., to manage biological aging, enabling users to take informed actions for maintaining users' health.

### Example Entropy Analysis System

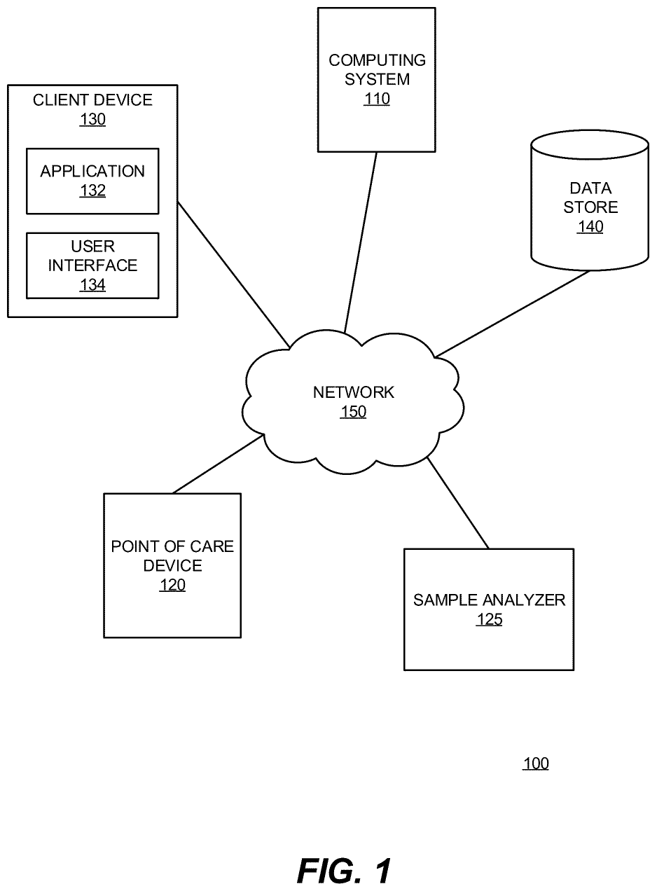

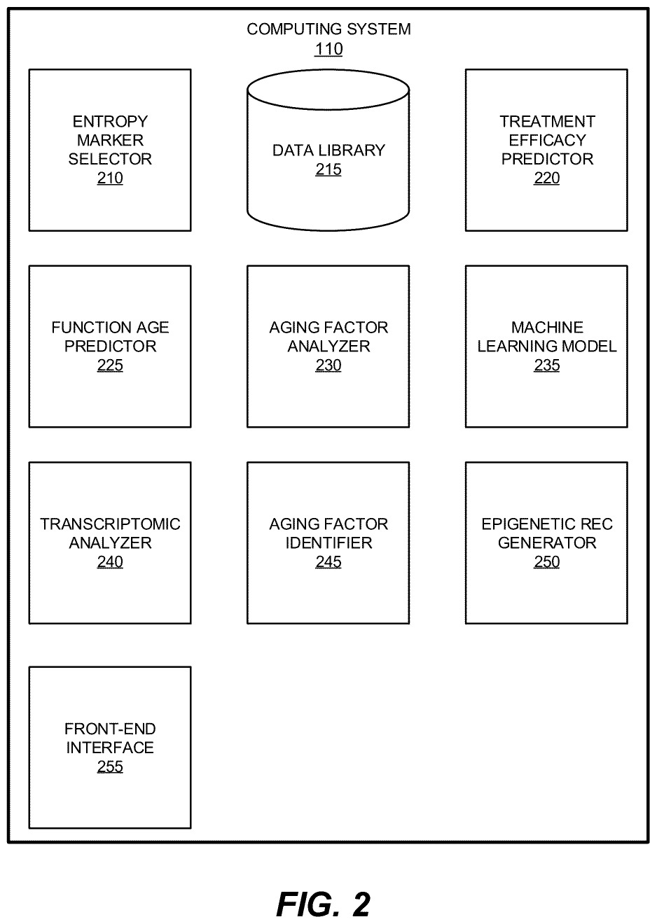

FIG. 2 is a block diagram illustrating various components of an example computing system 110, in accordance with some embodiments. A computing system 110 may include entropy marker selector 210, data library 215, treatment efficacy predictor 220, function age predictor 225, aging factor analyzer 230, machine learning model 235, transcriptomic analyzer 240, aging factor identifier 245, epigenetic recommendation generator 250, and front-end interface 255. In various embodiments, the computing system 110 may include fewer or additional components. The computing system 110 also may include different components. The functions of various components in computing system 110 may be distributed in a different manner than described below. Moreover, while each of the components in FIG. 2 may be described in a singular form, the components may present in plurality.

In some embodiments, the entropy marker selector 210 identifies a panel of relevant entropy makers relevant to assessing biological age and organ-specific functions. The entropy markers may include CpG sites, but may also include other types of markers such as histone modifications, non-coding RNAs (e.g., microRNAs), DNA hydroxymethylation, chromatin accessibility, histone methylation, histone acetylation, RNA methylation (e.g., m6A), DNA-binding protein interactions, and chromatin looping structures. This selection may be based on analyzing genetic data, which includes DNA methylation information gathered from multiple biological samples. The selection may be individual-based, group-based, and/or population-based, depending on the embodiments. In some embodiments, the entropy marker selector 210 evaluates changes in methylation patterns at various CpG sites over time and identifies CpG sites that display significant changes related to aging. The entropy marker selector 210 may use models (e.g., statistical models, algorithmic models, heuristic models, machine learning models) to determine which CpG sites correlate strongly with biological age changes, thus identifying markers that can provide insights into aging processes within different organismal systems. The entropy marker selector 210 may categorize selected CpG sites into groups, such as those associated with cardiovascular function, immune response, brain and neural system, etc., enabling a more targeted analysis of organ-specific aging.

In some embodiments, the entropy marker selector 210 can be tailored to work with different types of input data, such as DNA methylation levels obtained through various sequencing methods like bisulfite sequencing or next-generation sequencing (NGS). The entropy marker selector 210 can process data from different population groups, considering variations in age, ethnicity, or lifestyle factors that might influence methylation. The entropy marker selector 210 can also adapt to different statistical models, such as linear regression or machine learning-based approaches, to refine the selection of CpG sites. In some embodiments, the entropy marker selector 210 may adjust its methodology based on technological advancements in methylation profiling to select markers that remain relevant even as newer methods or analytical tools become available. This flexibility allows for the creation of customized panels suitable for a range of applications, from home-based tests to in-depth laboratory analyses.

In some embodiments, the data library 215 stores and manages various types of biological data, including DNA methylation data, transcriptomic data, and proteomic data, obtained from multiple biological samples. This data includes information related to CpG sites, gene expression levels, protein markers, and other epigenetic indicators that are used to analyze the aging process and assess organ-specific functions. The data library 215 may serve as a centralized repository, allowing the computing system 110 to access historical and real-time data for continuous analysis. The stored data can be used for tracking changes in entropy markers over time, determining system age trajectories, and evaluating the efficacy of personalized health recommendations. Additionally, the data may be used to conduct the longitudinal analysis of an individual's biological aging, enabling comparisons across multiple time points and data types.

In some embodiments, the data library 215 may support various data formats, including raw sequencing data, processed methylation levels, or summarized statistics. The data can be stored in structured formats like relational databases or unstructured data stores such as data lakes. The data library 215 may also integrate external data sources, such as public databases or clinical trial datasets, to enhance the scope and depth of the analysis. In different embodiments, various data storage architectures may be used, like cloud-based storage, local servers, or hybrid systems, to ensure flexibility in data access and scalability. The data library 215 may include features for data redundancy, automated backup, and encryption to maintain data integrity and security. The data library 215 may take the form of a database, data warehouse, data lake, distributed storage system, cloud storage platform, file-based storage system, object storage, graph database, time-series database, or in-memory database, etc. The data library 215 allows the computing system 110 to process large datasets efficiently while ensuring data reliability.

In some embodiments, the treatment efficacy predictor 220 analyzes the impact of various treatments on the biological markers of aging. The treatment efficacy predictor 220 tracks changes in DNA methylation levels at specific CpG sites before and after a treatment, using data from the data library 215. By tracking changes through a treatment process, the treatment efficacy predictor 220 evaluates whether a particular treatment, such as a dietary adjustment, supplement intake, lifestyle change, or medical or therapeutic treatment, has caused statistically significant epigenetic modifications. The analysis may include statistical models or machine learning algorithms that detect shifts in methylation patterns and correlate these changes with improvements in organ function or overall biological age. The treatment efficacy predictor 220 allows the computing system 110 to quantify the effectiveness of treatments and tailor recommendations based on the observed outcomes.

In some embodiments, the treatment efficacy predictor 220 can provide analyses of various types of treatments, including medical interventions, nutritional plans, and physical exercise regimens. The treatment efficacy predictor 220 may analyze data from different types of biological samples, such as blood, saliva, or tissue samples, depending on the source of methylation data. The treatment efficacy predictor 220 may use different statistical methods like regression analysis or mixed-effects models to accommodate variability in the data. The treatment efficacy predictor 220 can also incorporate longitudinal data, comparing treatment effects over time to understand the sustainability of the changes observed. Additionally, the treatment efficacy predictor 220 can be adjusted to include new treatment types as new treatment types become available or to refine the analysis based on emerging research, clinical trials and clinical data making it a flexible tool for assessing a wide range of interventions aimed at slowing the aging process.

In some embodiments, the function age predictor 225 estimates the temporal progression of a specific function in a complex self-regulating system, such as the biological age of a specific organ of an individual. The function age predictor 225 may analyze entropy markers associated with the organ, such as the changes in DNA methylation patterns at selected entropy markers (e.g., selected CpG sites) associated with the organ. The organismal system age predictor 225 may use data collected from various biological samples, such as blood or tissue, to determine the methylation state of specific markers associated with the aging process in different organs. By comparing these methylation patterns against reference data from a reference population, the function age predictor 225 estimates how the biological age of an organ compares to the user's chronological age. The function age predictor 225 allows the computing system 110 to provide insights into which organs may be aging faster or slower than expected, facilitating targeted health recommendations for those organs.

In some embodiments, the function age predictor 225 can be configured to assess the biological age of a range of organs and key systems in body, such as the heart, liver, kidneys, immune system, brain, inflammations or lungs. The function age predictor 225 can use various statistical models, including regression models, machine learning algorithms, or time-series analysis, to predict organ-specific aging trajectories. The predictor can also analyze different types of input data, such as DNA methylation data, RNA expression data, or protein levels. In some embodiments, the function age predictor 225 can adjust the reference data based on demographic factors such as age, sex, and ethnicity, ensuring that the predicted biological age of each organ is tailored to the user's characteristics or a group to which the user is classified. The function age predictor 225 may adapt its predictions to different populations and research settings, offering precise insights into organ and system-specific aging dynamics.

In some embodiments, the aging factor analyzer 230 identifies and assesses biological factors that influence the aging process, using data from DNA methylation patterns, gene expression, and other entropy markers. The aging factor analyzer 230 analyzes changes in these markers across various time points and correlates the changes with known aging pathways or biological processes. By evaluating the relationship between methylation changes at specific CpG sites and age-related cellular changes, the aging factor analyzer 230 identifies key factors that contribute to aging, such as inflammation, oxidative stress, or cellular senescence. The aging factor analyzer 230 provides information to the computing system 110 to map out how different biological processes interact and impact the aging of various organs and tissues, enabling a deeper understanding of the mechanisms driving biological aging.

In some embodiments, the aging factor analyzer 230 can process different types of biological data, such as transcriptomic data from RNA sequencing, proteomic data from protein assays, or even external data from clinical studies. The aging factor analyzer 230 may use diverse analytical approaches, including linear models, logistic regression, or machine learning techniques, to determine complex relationships between age-related changes and biological markers. Additionally, the aging factor analyzer 230 can work with multi-omic data, combining information from DNA methylation, gene expression, transcriptomic and protein modifications to provide a comprehensive view of the aging process. In some embodiments, the aging factor analyzer 230 is adaptable to different analytical scales, from broad population-level studies to more targeted, individual-specific analyses.

In some embodiments, the machine learning model 235 is designed to enhance the analytical capabilities of the computing system 110 by automating the identification of patterns and relationships in large-scale biological data. The machine learning model 235 may be used to analyze DNA methylation data, gene expression, protein levels, and other entropy markers to detect correlations between these markers and the biological aging process. By training on datasets containing information from different individuals across a broad age range, the machine learning model 235 learns to predict biological age, assess organ function, and evaluate the effects of treatments on aging markers. The machine learning model 235 allows the computing system 110 to make more accurate and personalized predictions regarding a user's biological age and potential health interventions.

In some embodiments, the machine learning model 235 can be configured to use various algorithms, such as supervised learning techniques like regression or classification models, or unsupervised learning approaches like clustering and dimensionality reduction. The machine learning model 235 can be trained on different types of input data, including longitudinal entropy data, demographic information, and lifestyle factors, to improve its predictive accuracy. The machine learning model 235 may also incorporate advanced techniques such as deep learning, neural networks, or ensemble learning, to process complex relationships between multiple biological variables.

In some embodiments, the transcriptomic analyzer 240 analyzes RNA expression data to provide insights into gene activity and how gene activity changes with age. The transcriptomic analyzer 240 may assess the transcriptional state of genes across various tissues or organs and generate data related to how gene expression patterns shift in relationship to aging processes. By analyzing RNA sequences obtained from biological samples, such as blood or tissue, the transcriptomic analyzer 240 identifies changes in gene activity that may be indicative of aging or age-related conditions. The transcriptomic analyzer 240 evaluates the levels of different RNA transcripts, allowing the computing system 110 to correlate these expression changes with other entropy markers, such as DNA methylation at CpG sites, to build a comprehensive view of the underlying mechanisms that drive biological aging.

In some embodiments, the transcriptomic analyzer 240 can process data from various RNA sequencing methods, including bulk RNA-seq or single-cell RNA-seq, to capture gene expression patterns at different resolutions. The transcriptomic analyzer 240 may employ statistical models, such as differential expression analysis, to identify genes that are significantly upregulated or downregulated with age. In some embodiments, the transcriptomic analyzer 240 can integrate gene expression data with other omics data, such as proteomics or methylomics, to explore the interplay between gene transcription and epigenetic regulation. This integration allows the computing system 110 to refine its analysis of age-related changes at the molecular level. The transcriptomic analyzer 240 can also adapt its analysis approach based on different tissue types or organismal systems, tailoring its assessments to specific contexts such as cardiovascular function, immune response, brain and neural system, etc., providing a more targeted and detailed understanding of age-related transcriptional changes.

In some embodiments, the aging factor identifier 245 identifies key biological markers, processes, and other factors that significantly influence aging. The aging factor identifier 245 may analyze data related to DNA methylation, gene expression, protein levels, and other epigenetic indicators to identify specific factors that correlate with the biological aging process. The aging factor identifier 245 examines how changes in these markers, such as shifts in the methylation status of CpG sites or variations in gene expression, contribute to the aging of cells and tissues. By evaluating these correlations, the aging factor identifier 245 generates data for the computing system 110 to detect molecular signatures that are most strongly associated with aging and identify which factors may drive age-related changes in different organs and tissues.

In some embodiments, the aging factor identifier 245 can utilize various analytical approaches, such as regression analysis, clustering, or machine learning models, to isolate factors that show significant associations with aging. In some embodiments, the aging factor identifier 245 can process multi-omic data, including transcriptomic, proteomic, and methylomic datasets, to integrate information across different biological layers. The aging factor identifier 245 may analyze different datasets and research contexts, including data from diverse reference populations to account for variations in aging across different demographics. In some embodiments, the aging factor identifier 245 can categorize identified factors into groups such as those related to inflammation, oxidative stress, or cellular senescence, providing a more detailed understanding of the specific pathways involved in the aging process.

In some embodiments, the epigenetic recommendation generator 250 generates personalized health and lifestyle recommendations based on a user's unique epigenetic profile. The epigenetic recommendation generator 250 may use data from DNA methylation analysis, gene expression levels, and other biological markers and data generated from various engines, such as the entropy marker selector 210, the treatment efficacy predictor 220, the function age predictor 225, the aging factor analyzer 230, the machine learning model 235, the transcriptomic analyzer 240, and the aging factor identifier 245, to generate suggestions that aim to optimize the user's health and potentially slow the aging process. The recommendations may include lifestyle modifications, dietary adjustments, supplement intake, or exercise plans, stress management techniques, sleep optimization strategies, personalized skincare routines, hydration guidelines, intermittent fasting protocols, recommendations for reducing exposure to environmental toxins, etc. The recommendations may be tailored to address specific age-related changes identified in the user's entropy data. By analyzing patterns in the entropy markers and correlating the markers with known interventions, the epigenetic recommendation generator 250 generates recommendations that guide users in making informed decisions to maintain or improve their biological health.

In some embodiments, the epigenetic recommendation generator 250 can generate recommendations based on various types of input data, such as longitudinal tracking of methylation levels, changes in gene expression, and feedback from users regarding the effectiveness of previous recommendations. The epigenetic recommendation generator 250 may use algorithms like heuristic algorithms, rule-based algorithms, statistical models, decision trees, regression models, or machine learning techniques to refine the recommendations. In some embodiments, the epigenetic recommendation generator 250 may integrate external data sources, such as information from wearable devices or third-party applications 132, to provide more comprehensive and accurate recommendations. More examples of third-party applications 132 are discussed in FIG. 1 in association with the discussion of the application 132. The epigenetic recommendation generator 250 may adjust recommendations based on demographic factors like age, gender, or lifestyle habits, ensuring that the advice is customized to the user's specific needs. This dynamic approach allows the epigenetic recommendation generator 250 to continuously update its guidance, making the epigenetic recommendation generator 250 a flexible tool for supporting long-term health and wellness through personalized epigenetic insights.

The front-end interface 255 may be a software application interface that is provided and operated by the computing system 110. For example, the computing system 110 may provide a SaaS platform or a mobile application for use to receive epigenetic analysis and recommendations. In some embodiments, the front-end interface 255 may take the form of various types of applications. For instance, the front-end interface 255 may be a standalone mobile app that users can download on their smartphones or tablets, allowing them to track their biological age, receive real-time recommendations, and view progress charts directly from their personal devices. In some embodiments, the front-end interface 255 may also be implemented as a web-based interface, accessible through standard web browsers. In some embodiments, the front-end interface 255 may take the form of a universal application, integrating multiple functionalities into a single cohesive platform. This universal application can serve as a centralized hub for users to access various services, such as tracking their entropy data, receiving personalized recommendations, and monitoring progress over time. The universal application may integrate data from third-party health apps, wearable devices, and other health monitoring systems, providing a seamless experience where users can access their complete health profile in one place. The function age predictor 225 may include features like real-time notifications, interactive dashboards, and data visualization tools that allow users to easily understand their biological age trends, lifestyle impacts, and treatment outcomes.

The front-end interface 255 may take different forms. In one embodiment, the front-end interface 255 may control or be in communication with an application that is installed in a client device 130. For example, the application may be a cloud-based SaaS or a software application that can be downloaded in an application store (e.g., APPLE APP STORE, ANDROID STORE). The front-end interface 255 may be a front-end software application that can be installed, run, and/or displayed on a client device 130. The front-end interface 255 also may take the form of a webpage interface of the computing system 110 to allow clients to access data and results through web browsers. In some embodiments, the front-end interface 255 may not include graphical elements but may provide other ways to communicate, such as through APIs.

### Example Epigenetic Recommendation Pipeline

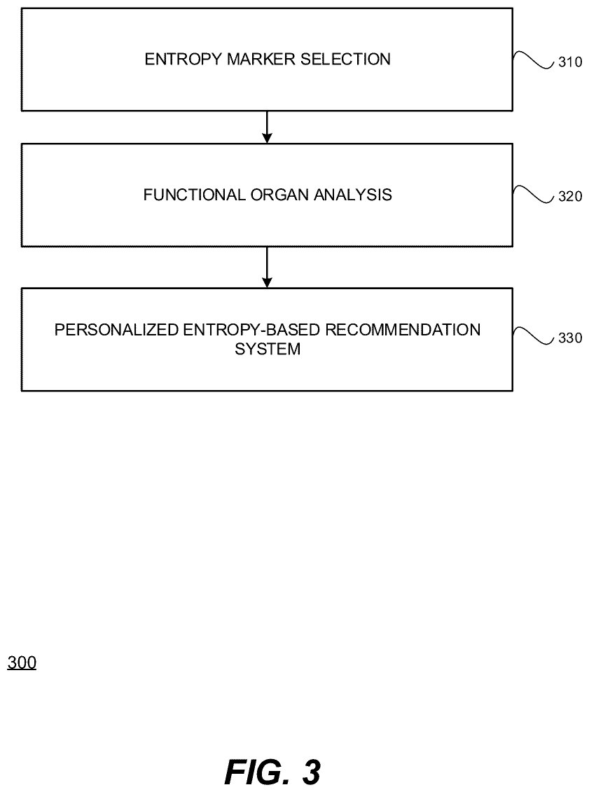

FIG. 3 is a block diagram illustrating an example epigenetic recommendation pipeline 300, in accordance with some embodiments. In some embodiments, the pipeline 300 may include an entropy marker selection stage 310, a functional organ analysis stage 320, and a personalized entropy-based recommendation stage 330. In some embodiments, the epigenetic recommendation pipeline 300 is performed by one or more components of the computing system 110, such as the entropy marker selector 210, the treatment efficacy predictor 220, the function age predictor 225, the aging factor analyzer 230, the machine learning model 235, the transcriptomic analyzer 240, the aging factor identifier 245, the epigenetic recommendation generator 250, and the front-end interface 255. Collectively, those components are referred to as the computing system 110. Features discussed in FIG. 2 may be used in any of the stages in the pipeline 300.

In some embodiments, at entropy marker selection stage 310, the computing system 110 performs marker selection by identifying entropy markers (e.g., CpG sites) that serve as indicators for understanding biological age and organ function. The computing system 110 may receive genetic data, which includes DNA methylation information from multiple biological samples. The samples may come from a diverse population across various age groups (e.g., individuals aged 20 to 90). The computing system 110 evaluates changes in methylation patterns over time. The computing system 110 selects CpG sites that demonstrate significant methylation changes or stability with age, differentiating those that are responsive to biological aging from those that remain constant.

In some embodiments, at entropy marker selection stage 310, the computing system 110 applies statistical models to identify entropy markers (e.g., CpG sites) that are statistically relevant for assessing age-related methylation changes. For example, the computing system 110 might use a statistical model that defines the relationship between the variance of a dependent variable, such as methylation level, and independent variables like age or biological conditions. The computing system 110 may evaluate these relationships on different scales, such as entropy like non-linear or log-linear scales, to account for variations across different CpG sites. By utilizing these models, the computing system 110 identifies sites where changes in methylation have a statistically significant correlation with aging processes, allowing for the selection of the most pertinent sites for further analysis.

Based on the identified potential CpG sites, the computing system 110 may also categorize the CpG sites based on the sites' relevance to specific organs or systems. In some embodiments, the organ-specific selection involves grouping CpG sites according to their biological roles, such as those associated with inflammation, fibrosis, or bone health. For instance, the computing system 110 may focus on CpG sites related to the cardiovascular system when assessing heart health or sites linked to the immune system when analyzing immune function.

The selected entropy markers (e.g., CpG sites) may be used to form a customized panel that may be tailored for specific testing needs, such as home-based tests. The panel may include sites that are most informative for tracking biological aging and other key health indicators. This flexibility in CpG site selection allows the system to adapt to different testing formats, ranging from detailed laboratory analyses to simpler at-home kits. This adaptability is essential for providing personalized insights into a user's aging process and health status, enabling more precise recommendations and interventions in subsequent stages of analysis.

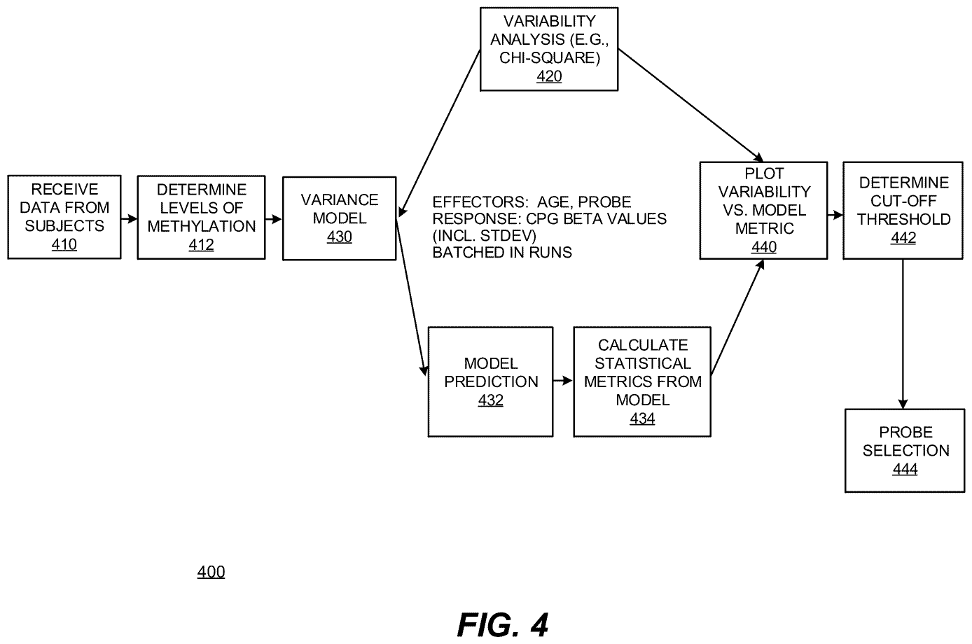

Further detail and an example implementation of the entropy marker selection stage 310 is described in FIG. 4.

In some embodiments, at the functional organ analysis stage 320, the computing system 110 performs functional organ analysis using the selected panel of entropy markers (e.g., CpG sites) to evaluate temporal progression (e.g., biological aging) within specific organs. The computing system 110 may analyze the entropy markers identified in stage 310. For example, the computing system 110 may focus on how the methylation patterns correspond to biological functions of various organs or systems. By correlating changes in methylation levels at specific CpG sites with known age-related markers, the computing system 110 can assess the aging status and functional integrity of each targeted organ.

The computing system 110 examines methylation changes longitudinally, comparing data across different time points from the same individual or across different individuals spanning a broad age range. The computing system 110 may track the trajectory of methylation changes over time, providing insights into how the function of a particular organ evolves with aging. For instance, the computing system 110 may analyze how methylation levels change in CpG sites related to an organ's function, allowing the computing system 110 to determine whether a user's organ is aging at a typical rate or showing signs of accelerated aging.

In some embodiments, at functional organ analysis stage 320, the computing system 110 may apply models to quantify the rate of aging within each system and organ. The computing system 110 may determine the relationship between changes in methylation levels and the chronological age of the individual or the biological age of the organ. For example, the computing system 110 might use a model that estimates how rapidly methylation levels change at specific CpG sites over time, translating this into a rate of aging for a particular organ. Such models can be applied across a range of organs to identify areas where the aging process may be slower or faster than expected, offering a detailed picture of a user's overall biological aging profile.

In some embodiments, at entropy marker selection stage 310, the computing system 110 may map the selected CpG sites to the biological pathways that regulate functions within the target organs. The computing system 110 may determine how changes in methylation at specific sites influence gene expression and regulatory pathways within those organs. For example, the computing system 110 may identify CpG sites that regulate genes involved in inflammatory responses within the immune system, providing a detailed understanding of how immune function changes with age. Based on the mappings, the system establishes connections between the entropy markers and the physiological processes that the markers influence.

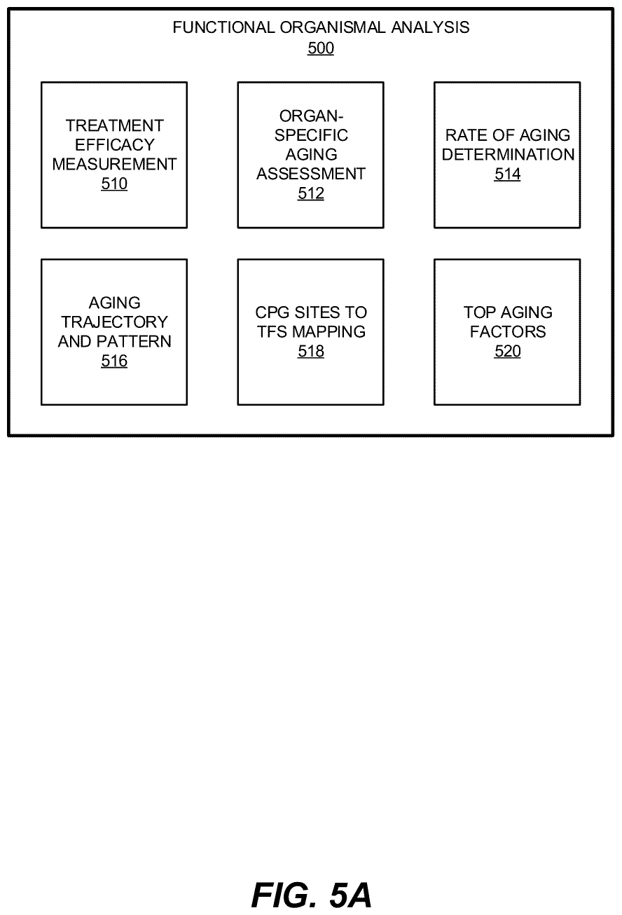

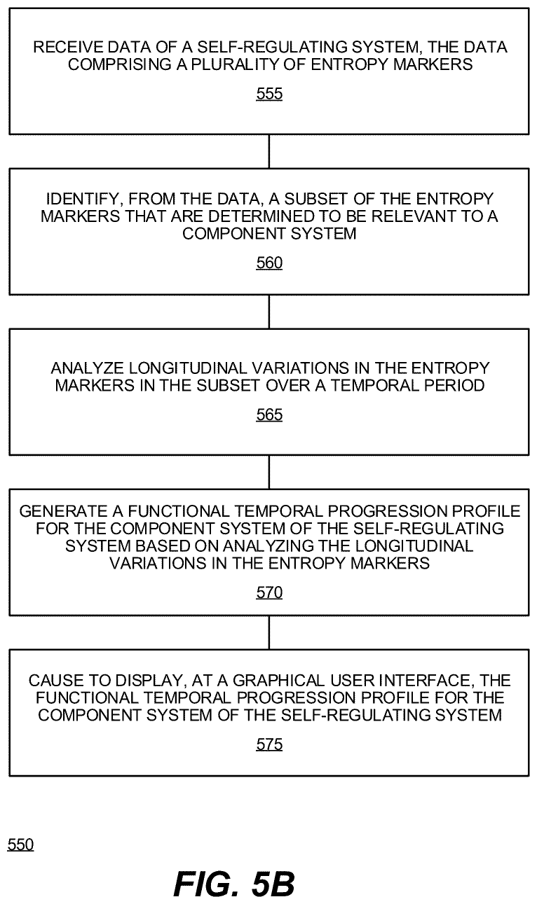

Further detail and an example implementation of the functional organ analysis stage 320 is described in FIG. 5A.

In some embodiments, at the personalized entropy-based recommendation stage 330, the computing system 110 provides personalized epigenetic-based recommendations. The recommendations may be based on various types of data, such as the results from the entropy marker selection stage 310, the results from the functional organ analysis stage 320, and external data. For example, the computing system 110 may use determinations generated from the CpG methylation data to tailor specific health interventions for the individual, focusing on slowing the aging process and improving the overall functionality of various organs. The recommendations may be based on the methylation patterns identified at specific CpG sites, which indicate how different organismal systems are aging and their current biological states.

In some embodiments, at the personalized entropy-based recommendation stage 330, the computing system 110 identifies relationships between specific biomarkers and aging processes. The computing system 110 may use a scoring function to rank the identified relationships. The scoring function integrates CpG methylation data, organ-specific aging information, and other variables like environmental factors or lifestyle data that may have been gathered from user inputs. In some embodiments, the scoring can also be informed by insights from scientific literature, using metrics such as citation counts to identified biomarkers that have been well-studied and widely recognized. The scoring function may also account for the statistical significance of the associations between a biomarker and aging, such as by weighing relationships with lower p-values or stronger effect sizes, clinical endpoints more heavily to the score. In some embodiments, the computing system 110 may also consider the sample size of studies or datasets that support a particular biomarker's relevance to aging. These combined factors allow the scoring function to provide a nuanced assessment of the strength and reliability of each biomarker's link to the aging process.

Based on a scoring function that ranks identified relationships, the computing system 110 may use one or more recommendation algorithms to generate personalized advice. The algorithms may translate findings from the methylation data into practical health recommendations that the user can follow. For example, if the analysis indicates that the methylation markers related to bone health show signs of accelerated aging, the system might recommend interventions such as increased vitamin D intake or specific dietary adjustments to improve bone density. The recommendations can also include lifestyle changes, such as modifications in exercise routines, tailored to target the specific needs of the aging patterns identified in different systems and organs.

The system's recommendation process takes into account various factors that can influence biological aging, including genetic predispositions, current health status, and historical data may include family history from previous analyses. By continuously monitoring changes in CpG methylation patterns, the computing system 110 adapts its recommendations over time to ensure they remain relevant as the user's biological markers evolve. For example, if the methylation patterns related to cardiovascular function improve after a specific intervention, the system might adjust its focus to other areas that need more attention, such as immune function or metabolic health.

In some cases, the computing system 110 may also integrate external data sources to enhance the precision of its recommendations. This can include data from public repositories or clinical trials that provide insights into the efficacy of various interventions, such as certain supplements, medicines, longevity interventions and treatments or lifestyle practices. The external data may also include any third-party applications 132, as discussed in FIG. 1. The computing system 110 may use various data to rank the potential benefits of different interventions for a specific user, generating a prioritized list of actions that are most likely to improve the biological age of a particular organ or the overall health status. For instance, the computing system 110 might recommend a specific type of supplement or therapeutic regimen based on its proven impact on related to liver function.

In some embodiments, the computing system 110 integrates its personalized recommendations with external platforms or applications to enhance user engagement and implementation of health advice. For example, the system may synchronize with daily user applications 132, allowing users to track their adherence to recommendations like dietary changes or physical activities directly through a mobile interface. This integration facilitates a seamless connection between the analysis performed by the computing system 110 and the real-world actions taken by the user. The computing system 110 may provide personalized guidance that is implemented effectively in daily life.

At personalized entropy-based recommendation stage 330, the computing system 110 may generate recommendations that are specifically tailored to the unique epigenetic profile of each user. The computing system 110 provides a personalized approach using data unique to the user's biological age and system, organ function gained through a periodic collection of the user's samples, such as through a subscription model. By focusing on how methylation patterns can be influenced through targeted actions, the computing system 110 provides incentive to users to actively manage their biological aging. The recommendations aim to slow the aging of specific organs, maintain optimal function, and ultimately improve the user's overall well-being. By offering tailored guidance that evolves with each new analysis, the computing system 110 provides a highly personalized pathway for users to optimize their health. The system's ability to connect specific entropy markers to actionable interventions provides a data-driven roadmap for managing age-related changes.

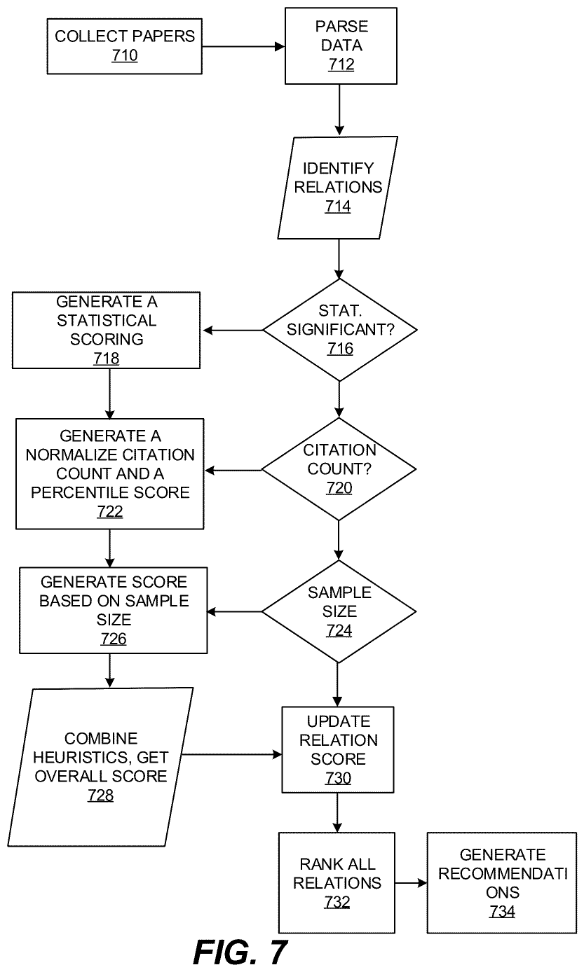

Further detail and an example implementation of the personalized entropy-based recommendation stage 330 is described in FIG. 7.

### Identification of Key Entropy Sites

FIG. 4 is a block diagram illustrating a pipeline 400 for identifying key entropy markers, in accordance with some embodiments. The pipeline 400 may be an example of the stage 310 described in FIG. 3. In some embodiments, the entropy markers can be markers of biological entropy such as dysregulation of CpG sites, RNA, DNA, proteins metabolites. In FIG. 4, entropy sites such as CpG sites are used as examples, but in various embodiments the entropy markers can be any other suitable entropy markers. While the pipeline 400 is primarily described as being performed by the computing system 110, in various embodiments the pipeline 400 may also be performed by any suitable computing devices. In some embodiments, one or more steps in the pipeline 400 may be added, deleted, or modified. In some embodiments, the steps in the pipeline 400 may be carried out in a different order that is illustrated in FIG. 4. Also, while the selection process is primarily using the selection of CpG sites as examples, the pipeline 400 may also be applied to selecting other entropy markers.

In some embodiments, at stage 410, the computing system 110 receives data from subjects. The data may be generated by the point-of-care device 120 or the sample analyzer 125. The data may be biological data such as entropy data from a diverse population of subjects across various ages. For example, in one experiment, the data includes DNA methylation information from over 800 subjects, who span a wide age range. The data is used for the computing system 110 to perform a comprehensive analysis of epigenetic changes over time. The age distribution of the subjects may range from young adults in their twenties to elderly individuals in their eighties or nineties. The computing system 110 analyzes the data to observe how DNA methylation varies between individuals and across the aging spectrum and in different systems. The computing system 110 may establish patterns or trends in how methylation changes over time. The patterns may be used for downstream processes, such as determining biological age, identifying age-related biomarkers, and predicting health or related disease outcomes.

In some embodiments, the computing system 110 may organize the subjects into appropriate batches or groups, facilitating the statistical and computational processes required to analyze the large dataset. Batching may be performed in a suitable way based on age-related methylation changes. In some embodiments, the system processes data in smaller batches, such as groups of about twenty subjects. Each batch can then undergo further statistical analysis as part of the loglinear variance model or other computational models employed by the system 110.

In some embodiments, at stage 412, the computing system 110 determines the level of DNA methylation of a subject from a collection of probes. For example, the levels of DNA methylation may take the form of beta values from a collection of CpG probes. The CpG probes are specific sites within the DNA where methylation occurs, serving as key markers for epigenetic changes. The system 110 may receive data corresponding to a wide array of CpG probes, such as 460 distinct CpG sites in one implementation, each of which captures the methylation status at a particular locus. These CpG sites are chosen for their relevance in measuring biological changes, often due to their correlation with aging or organ-specific functions. The selection of these sites can be based on prior research, clinical studies, or proprietary data regarding their impact on biological age or organ health.

The computing system 110 processes the incoming data related to the methylation levels. For example, beta values are continuous measures of methylation levels at each CpG site. The values typically range between 0 and 1, where a value closer to 0 represents a lower methylation level (unmethylated), and a value closer to 1 indicates a higher methylation level (methylated). The computing system 110 is designed to handle high-throughput data, processing large volumes of beta values efficiently to generate insights into the epigenetic state of the subjects under analysis. The beta values may be the raw data for further statistical modeling and analysis performed by the computing system 110, providing a baseline for understanding epigenetic modifications across the genome.

In some embodiments, at stage 420, the computing system 110 processes data related to the probes and assess how the observed variability in the entropy data in each probe compares to the expected variability from reference population data. By way of example, the probes may be CpG probes, and the measurement of the entropy data may take the form of methylation levels. For example, the computing system 110 may determine how the observed variability in the methylation levels of the subjects (e.g., the beta values) compares to the expected variability from the reference population data. The computing system 110 uses the analysis to identify CpG sites where the methylation levels are significantly associated with factors such as age or other biological conditions. The variability may be determined based on a statistical metric.

By way of example, at stage 420, the computing system 110 may compute a chi-squared value for each probe. The chi-squared value is calculated based on the variability of the CpG probe's methylation levels across the subjects being analyzed. Specifically, the chi-squared test assesses whether the observed variance in the methylation levels significantly deviates from what would be expected under a null hypothesis where no association exists between methylation level changes and age or other effectors. In some embodiments, the computing system 110 receives the data related to methylation levels from the selected CpG probes. These methylation levels, which may be represented as beta values, indicate the proportion of methylation at each CpG site. The chi-squared test is used to compare the observed variability in the beta values across the cohort of subjects with the expected variability. The system may use this statistical test to examine the relationship between age and methylation levels, or between other factors and methylation.

In some embodiments, to perform the chi-squared test, the computing system 110 may define expected beta value distributions for each CpG probe based on known baselines or control groups, such as from a reference population. The computing system 110 may include data such as demographic and biological characteristics such as age, gender, or health conditions. The computing system 110 may compare the actual distribution of the observed beta values from the subjects to the expected distribution to determine the chi-squared statistic. The statistic measures how far the observed data diverges from the expected model. The computing system 110 measures the influence of the effectors (e.g., age, health conditions).

In some embodiments, at stage 430, the computing system 110 uses a model such as a statistical model to describe the relationship between the variance in DNA methylation levels and one or more variables. The variables may include factors such as age, organs, metabolism, and/or CpG site locations. The model applied may take various forms, including but not limited to a loglinear variance model, where the relationship between the variance of methylation and the variables is expressed on a logarithmic scale. The model analyses patterns in how methylation variability evolves with age and other factors to provide a view of the changes in the epigenetic landscape over time. In addition to or alterative to loglinear model, the computing system 110 may also uses other statistical distributions to construct a model, such as entropy curve aging model with biological data using a linear model, a regression model, a Poisson model, a logistic model, a binomial model, a Bayesian model, a multinomial model, and another combination of models.

By way of example, at stage 430, the computing system 110 applies a statistical approach to a dataset containing methylation levels, for example, from over hundreds of CpG sites (e.g., 460 sites) that are selected for their relevance to aging processes, specific biological functions, and/or specific organs. The CpG sites may represent loci where DNA methylation that the computing system 110 predicts to play certain roles in regulating gene expression, impacting biological processes like inflammation, fibrosis, or bone health. The selection of the initial sites may be performed manually or based on data in other scientific papers. The selection of the CpG sites can also be based on prior research or proprietary methodologies.

Using the framework of the loglinear variance model as an example, the computing system 110 accounts for the variance in methylation data as a function of both age and the specific CpG site under analysis. The computing system 110 may consider various interactions between age and other covariates, which allows for a dynamic understanding of how entropy markers respond differently in individuals of varying ages. For instance, the model can detect whether the variance in methylation levels increases with age at certain CpG sites, which might indicate that these sites are more susceptible to environmental influences or biological noise over time.

In some embodiments, the system 110 processes the data in a batched manner, grouping subjects into smaller cohorts (e.g., about 20 subjects per batch) to ensure efficient computation and model fitting. This batch processing approach can help in managing large datasets, such as those derived from a study of a large number of subjects (e.g., over 800 subjects) across a broad age range. The batching may allow cross-validation of results to enhance the robustness of the findings.

In some embodiments, after the model at stage 430 is trained, at stage 432, the computing system 110 generates predictions, such as regarding methylation variability at different ages. For example, the computing system 110 may use a loglinear variance model to generate predictions concerning the variability in methylation levels at different ages. The predictions allow the computing system 110 to make inferences about how CpG methylation levels change over age and biological functions. In some embodiments, the model generates predictions regarding methylation variabilities various age ranges and different systems over body, such as between 20 years and 40 years old, between 40 years and 65 years old, between 65 years and 85 years old, etc. The computing system 110 may also perform other analyses of aging-related changes in entropy markers.

For instance, the model may simulate the expected distribution of methylation values for each CpG probe across a range of ages, such as between age 25 and age 80. The age range end points may be selected to represent early adulthood and late life to provide contrasting insights into how methylation patterns shift across a user's lifespan. The system environment 100 may identify CpG sites where the variability in methylation either remains stable or changes significantly with age. The generated predictions serve as a reference for subsequent or other statistical analyses, such as calculating the standard deviations of methylation levels and the chi-squared values that help assess the strength of age-related associations for each CpG probe.

The computing system 110 may simulate methylation levels at other ages or across a broader age range, such as by predicting methylation levels at every year, every 5 years, or every decade. In some embodiments, the computing system 110 may determine the methylation levels at the two end points, such as the ages 30 and 80 as reference points for understanding the pace and patterns of epigenetic aging. In some embodiments, using the predictions at the end points, the computing system 110 may extrapolate a continuous spectrum of methylation values, accounting for individual variability across the cohort.

In some embodiments, at stage 434, the computing system 110 calculates statistical metrics that quantify changes in the variability of methylation levels across different ages generated by the model trained at stage 430. The statistical metrics may be any suitable metrics, depending on embodiments. In some embodiments, a statistical metric may take the form of ASTDEV, which represents the change in the standard deviation of methylation levels between two different age points (e.g., 30 and 80 years old). In various embodiments, the change in the standard deviation is merely one example, and the computing system 110 may utilize a variety of other statistical measures to evaluate shifts in the methylation patterns. In some embodiments, change in variance, change in median deviation, change in interquartile range, change in coefficient of variation may also be used.

The computing system 110 utilizes these statistical metrics to model how variability in methylation levels changes with age. The computing system 110 may identify which CpG sites exhibit significant alterations in methylation variability over time. The computing system 110 can then analyze the statistical metrics to identify patterns that may be indicative of biological aging processes or responses to environmental factors.

In some embodiments, at stage 440, the computing system 110 plots the relationship between a variability metric derived from the variability analysis 420 and a model metric derived from the model at stage 430. The variability metric represents the observed variability in the methylation levels at each CpG site across the cohort of subjects, compared to the expected variability based on control data or an established model. The metric may include, but is not limited to, a chi-squared value. In various embodiments, the computing system 110 may employ any suitable variability metric that quantifies the deviation of observed entropy data from expected norms, depending on the specific study design and statistical model in use.

In some embodiments, the model metric calculated by the computing system 110 at stage 434 reflects the spread or dispersion of the methylation levels across different ages or other relevant effectors. This could be based on the standard deviation of methylation values within a specific age group, or any other metric that quantifies the extent of variability in the methylation data across a population. For example, the system could compute the difference in standard deviations (ASTDEV) between methylation levels at two distinct age groups, such as 30 years old and 80 years old, to understand the age-dependent variability in methylation patterns. Alternatively, the system could calculate other statistical measures of central tendency and spread, such as variance, interquartile ranges, or z-scores, to characterize the distribution of methylation values across various groups of subjects.

The computing system 110 then generates a plot where the variability metric is plotted against the model metric across different CpG sites. This plot enables the identification of CpG sites that exhibit unusually high or low variability in their methylation patterns, compared to the expected variability, across the subjects under study. By visualizing the relationship between these two metrics, the computing system 110 can detect outlier probes or patterns that may be indicative of significant biological or epigenetic changes. The plot further assists in distinguishing CpG probes that are likely to be biologically relevant from those whose variability may simply result from random noise or measurement errors, supporting the subsequent application of cutoffs or thresholds to filter relevant probes for further analysis.

In some embodiments, at stage 442, the computing system 110 selects thresholds to select which probes demonstrate significant variability in entropy data based on the plot at stage 440. The system evaluates each probe by comparing a statistical metric that reflects observed variability in the methylation levels to the expected variability based on a predefined model. This comparison allows the system to identify whether the variability at a particular CpG site is statistically significant or within an acceptable range of deviation.

The computing system 110 may establish two or more thresholds for a CpG probe to be selected. The first threshold may be based on a variability metric that quantifies how much the probe's observed data deviates from its expected behavior, which is determined at stage 420. The second threshold may be related to the model metric that represents the magnitude of change or variability between specific conditions (for example, across different age groups, health conditions, or other effectors). In some cases, this second threshold could be based on the standard deviation or another metric that captures the spread of variability across conditions, which is determined at stage 434. The thresholds define cut-off values for selection.

In some embodiments, the threshold selection and the pipeline 400 in general used by the computing system 110 can be tailored to specific criteria, such as age, population demographics, organismal systems, or particular biological conditions. For example, when analyzing aging, the thresholds may be adjusted to account for age-specific variations in methylation patterns, allowing the system environment 100 to select thresholds that are particularly relevant to certain age groups. In some embodiments, population-specific thresholds can be set to account for differences in methylation patterns across various ethnic groups, genders, or other population demographics. In the case of organ-specific analyses, the computing system 110 may establish thresholds that are relevant to specific organs or biological systems, such as the cardiovascular or immune system, ensuring that variability metrics are aligned with organ-specific changes in methylation. Moreover, the computing system 110 may adjust thresholds based on situational factors, such as exposure to environmental conditions, diseases, or lifestyle factors, ensuring that the statistical metrics used to evaluate probes reflect the unique context of the subjects under analysis. By allowing the threshold selection to be dynamic and adaptable, the computing system 110 provides a highly customizable framework for identifying meaningful biological signals in diverse contexts.

In some embodiments, at stage 444, the computing system 110 selects the final probes that correspond to a list of CpG sites that are determined to be most significant. For each probe, the system compares the metric values of the probe and compares the metric values to the predefined cut-off values. For example, if the variability metric exceeds the first threshold, it may suggest that the CpG site shows significant divergence in methylation patterns, potentially indicating an association with an underlying biological effect such as aging. Likewise, if the second statistical measure, such as a change in standard deviation, exceeds the corresponding threshold, the computing system 110 may determine the variability observed is meaningful and not due to random fluctuations.

In some embodiments, the computing system 110 selects probes that surpass both cut-off thresholds are considered to demonstrate significant variability in methylation. This process allows the computing system 110 to filter out probes with insignificant variability and focus on those that provide meaningful insights into biological or epigenetic changes. By way of example, in some experiments, about 70 probes are selected out of a candidate set of 460 probes.

In some embodiments, the pipeline 400 implemented by the computing system 110 can be used in either a static or dynamic fashion, depending on the embodiments. In a static implementation, the computing system 110 may predetermine a fixed list of CpG probes based on prior studies, clinical relevance, or known associations with biological processes such as aging or disease. This fixed list may remain consistent throughout the analysis, allowing for standardized testing and comparison across subjects or populations. In some embodiments, the computing system 110 can also operate dynamically, where the selection of CpG probes is continuously adjusted based on dynamic factors affecting a use's environment. For example, the computing system 110 may consider current health status, recent lifestyle changes, environmental exposures, or ongoing treatments to dynamically modify the probe selection. In this embodiment, the pipeline 400, the model train at step 430, the metrics selected at step 420 and 434, and the threshold selected at step 442 may adapt to reflect the user's current biological state, optimizing the set of probes analyzed to account for these contextual factors. The dynamic approach allows for a more personalized and responsive analysis, enabling the computing system 110 to provide insights that are continuously tailored to the user's evolving health profile and environmental conditions.

### Functional Organ Analysis

FIG. 5A is a block diagram illustrating a functional organ analysis 500 that includes specific analyses used to analyze functional organ using entropy data, in accordance with some embodiments. The functional organ analysis 500 may be an example of the stage 320 described in FIG. 3. While the functional organ analysis 500 is primarily described as being performed by the computing system 110, in various embodiments the functional organ analysis 500 may also be performed by any suitable computing devices. In some embodiments, one or more specific analysis may be added, deleted, or modified compared to the examples shown in FIG. 5A. In some embodiments, the data can be related to markers of biological entropy such as dysregulation of CpG sites, RNA, DNA, proteins metabolites. In FIG. 5A, biological entropy markers such as CpG sites are used as examples, but in various embodiments the entropy markers can be any other suitable entropy markers

The computing system 110 may employs a systematic methodology to provide personalized intervention recommendations based on each user's system age analysis results. Initially, key metadata is extracted from systematic reviews and scholarly articles, including titles, abstracts, citation counts, and other pertinent details. These articles are then filtered using statistical metrics, such as citation counts and their relevance to specific interventions within a predefined intervention library. A comprehensive analysis is subsequently performed on the filtered articles using a specialized scoring function designed to identify and quantify relationships between various functions and interventions.

The final personalized recommendations are derived by combining the identified relationships with each user's system age analysis results. The recommendations may be divided into two categories: clinical recommendations and lifestyle recommendations. Clinical recommendations include therapies and medications, while lifestyle recommendations cover supplements, nutrition, and fitness.

In some embodiments, the computing system 110 evaluates treatment efficacy measurement 510 by analyzing changes in DNA methylation at selected CpG sites. The computing system 110 may receive entropy data of a subject who has undergone a particular treatment. The entropy data may be determined from biological samples analyzed by the point-of-care device 120 or the sample analyzer 125. The entropy data may be analyzed to identify specific CpG sites relevant to the treatment in question. The identification of the CpG sites may be determined by the pipeline 400. For example, the CpG sites are selected based on the sites' established correlation with specific organ functions and the sites' sensitivity to methylation changes during treatment.

In some embodiments, the treatment as used herein is not limited to conventional therapeutics or medical treatments involving pharmaceuticals or clinical procedures. In various embodiments, a treatment may encompass a broad range of interventions, including but not limited to dietary adjustments, lifestyle changes, modifications in daily habits, the administration of supplements, and other non-medical approaches aimed at improving health or slowing the aging process. For example, treatment may refer to the introduction of specific nutrients or vitamins into a person's diet, participation in a physical exercise regimen, or changes in sleep patterns, all of which may have significant biological effects measurable through entropy markers. The analysis conducted by the computing system 110 applies to any intervention that may influence the body's biological processes, as reflected in DNA methylation patterns at CpG sites, regardless of whether the intervention is classified as medical or non-medical.

In some embodiments, after the relevant CpG sites are identified and the methylation levels of those sites are identified, the computing system 110 monitors changes in methylation levels across these sites and across different samples measured at different times. The system may use a variety of statistical models and/or machine learning models to detect significant methylation shifts, indicating a biological response to the treatment. Possible models include traditional statistical approaches such as linear regression models, which can quantify the relationship between methylation levels and treatment effects, and generalized linear models (GLMs), which allow for the modeling of response variables that have non-normal distributions. The computing system 110 may also employ mixed-effects models to account for both fixed and random effects, particularly in longitudinal data where repeated measurements are taken over time. Machine learning techniques may be used to classify methylation changes and detect patterns that distinguish treated from untreated samples. For example, random forest models and deep learning models, including neural networks, may be applied for more complex, nonlinear pattern recognition. By comparing methylation data from before and after the treatment, the system can detect whether the treatment has had a measurable impact on the targeted biological processes.

The analysis may be further refined by organ-specific CpG panels, which allow the computing system 110 to focus on CpG sites that are directly involved in the functioning of specific organs. The computing system 110 may use the pipeline 400 to identify organ-specific CpG sites. This organ-specific approach enables a more detailed assessment of how treatment efficacy varies between different organismal systems. For instance, methylation changes in CpG sites related to cardiovascular function may provide insights into how a treatment impacts heart health, while changes in CpG sites associated with immune function may reveal effects on immune response.

The results of the analysis are used to generate an overall evaluation of the treatment's efficacy. The computing system 110 may correlate the results with other data, such as clinical outcomes or patient-reported improvements, to provide a comprehensive picture of the treatment's biological effectiveness. The treatment efficacy measurement 510 allows the computing system 110 to quantify the impact of a given treatment on the subject's biological age and organ function, based on precise entropy markers.

In some embodiments, the computing system 110 performs an aging assessment 512 within specific organ function by analyzing DNA methylation patterns at selected CpG sites. The computing system 110 identifies CpG sites that are associated with biological processes linked to various organ functions, such as inflammation, fibrosis, or bone health. The identification of the CpG sites may be performed using the pipeline 400. The CpG sites may be selected through a statistical analysis that evaluates how their methylation patterns change with age. The computing system 110 may compare methylation data from a wide age range of subjects, such as between 30 and 80 years old, between 20 and 90 years old, etc.

In some embodiments, the computing system 110 groups the CpG sites according to the sites' functional relevance to specific organs (e.g., organs or organismal systems). For instance, CpG sites related to inflammation are grouped for an assessment of immune function, while sites associated with bone metabolism are used to evaluate skeletal aging. The grouping allows for organ-specific aging analysis, enabling the system to determine how well an organ is functioning relative to the biological age of the individual. As part of this process, the system compares methylation levels at different time points to track changes in the biological age of each organ over time.

The comparison of methylation levels at different time points allows the computing system 110 to generate data on how aging is occurring within specific organs, which can be used to provide personalized health insights. For example, if the methylation patterns indicate accelerated aging in the cardiovascular system, the computing system 110 may flag this as an area of concern for potential early intervention. The computing system 110 may continuously update the information as new samples are provided, such as in a subscription model. The computing system 110 may offer a dynamic picture of aging across multiple organs.

In some embodiments, the computing system 110 may provide function analyses for 19 or more critical functions, each representing a vital function within the body. By way of example, the functions may include auditory health, blood and vascular health, blood sugar and insulin control, brain health and cognition, cardiac health, digestive health, fibrogenesis and fibrosis, hepatic health, immunity, inflammatory regulation, metabolism, muscular health, neurodegeneration, oncogenesis, reproductive health, respiratory health, skeletal health, tissue regeneration, and urinary health. Each function may be analyzed to provide a detailed understanding of the current state and aging trajectory, allowing for targeted interventions and monitoring.

In some embodiments, the computing system 110 performs a rate of aging determination 514 by analyzing longitudinal changes in DNA methylation patterns at specific CpG sites over a period of time, such as against a benchmark. The computing system 110 applies longitudinal samples to track how methylation patterns at the selected CpG sites evolve over time. For instance, in individuals aged 20 to 90, specific CpG sites that exhibit a significant change in methylation over time are closely monitored. The computing system 110 performs periodic data collection of a subject, comparing methylation states at each stage to a reference biological age model, which may be created from a broad population dataset or an individual baseline established in prior tests.

In some embodiments, the system 110 may employ statistical techniques to quantify the speed at which CpG methylation patterns change, thereby estimating the rate of biological aging. By comparing each set of longitudinal data against expected normative changes, the system 110 identifies deviations that signify either an acceleration or deceleration in the aging process. These changes may be mapped to organ-specific functions or overall biological aging indicators, allowing for a detailed and precise measurement of aging speed across different biological systems.

In some embodiments, the computing system 110 may further refine its analysis by integrating environmental, genetic, and lifestyle data that influence methylation changes to generate personalized aging rate. These rates may then be applied to assess treatment efficacy 510, provide health recommendations, or guide interventions aimed at slowing or reversing age-related biological changes.

In some embodiments, the biological age is calculated by employing a “noise barometer” approach, which focuses on cytosines with stable methylation throughout life. Biological age is measured by quantifying the dysregulation of these cytosines, using the sums of standard deviations of their methylation values as biomarkers of aging and disease. This method identifies increased biological noise as a key indicator of aging and disease. For the functional the biological age analysis, the approach is refined by examining the specific relationships between cytosines and genes. Each cytosine selected for the overall the biological age analysis is associated with particular genes, and these genes can be linked to specific biological functions. By defining the relationships between each cytosine and its corresponding genes, and subsequently mapping these genes to their respective functions, a unique list of cytosines pertinent to each function is established. This detailed mapping allows for the linkage of each cytosine to a specific function, thereby providing a comprehensive functional the biological age analysis that highlights the unique contributions of each biological system to the overall aging process.

In some embodiments, chronological age is defined as the actual age of an individual, measured in years from the date of birth. Chronological age serves as a baseline for comparing biological age and aids in understanding the aging process. It can be calculated using the following formula:

$$Chronological Age = Sample Collection Date - Date of Birth$$

In some embodiments, a system age represents an individual's biological age. The system age may also be referred to as the biological age. The system age is derived from various biomarkers that reflect the overall health and functioning of the body. Unlike chronological age, which merely measures the time passed, the system age offers a nuanced understanding of an individual's physical condition.

In some embodiments, the system age may be calculated through statistical analysis of biomarkers representing physiological states across body systems, thus providing a more precise representation of biological aging. The system age provides a more accurate representation of an individual's biological age, taking into account the complex interactions of different bodily functions.

In some embodiments, age difference is calculated to highlight discrepancies between the system age and chronological age. This measure identifies potential areas that may require attention by determining the difference between biological and chronological age. Age difference can be represented mathematically as:

$$Age Difference = System Age - Chronological Age$$

In some embodiments, aging speed quantifies the rate at which an individual is aging biologically in relation to chronological age. Aging speed, expressed as a ratio, provides valuable insight into the biological aging rate, facilitating the early detection of accelerated aging. The formula may take the form of:

$$Aging Speed = System Age / Chronological Age$$

In some embodiments, aging factors quantify the contribution of various biological functions to the overall aging process, such as a percentage. Each aging factor represents the relative impact of a specific biological function on the system age, calculated based on the age difference for that function. Aging factors enable the prioritization of interventions by identifying significant contributors to the aging process.

The aging factor for a specific function is calculated by taking the age difference related to that function and dividing it by the sum of the absolute age differences for all functions. The aging factor for a specific function i is calculated as follows:

$$Aging {Factor}_{i} = \frac{Age {Difference}_{i}}{{\sum }_{j = 1}^{n} \vert Age {Difference}_{j} \vert}$$

where

Aging Factor; is the aging factor for function (i) and Age Difference; is the age difference for function (i). n is the total number of functions. The summation is the sum of the absolute age differences for all functions.

In some embodiments, the computing system 110 provides insights into aging trajectories and patterns 516 across various organs by analyzing changes in DNA methylation at selected CpG sites. The system identifies specific CpG sites that are either organ-specific or linked to certain biological processes, such as inflammation or fibrosis. By tracking methylation changes over time in aging assessment 512 and rate of aging determination 514, the computing system 110 creates a trajectory that reflects how aging progresses within a specific organ.

In some embodiments, to develop an aging trajectory, the computing system 110 may factor in both stable CpG sites, which are sites that show little to no change over time, and dynamic CpG sites, which demonstrate significant variation in methylation levels with age. The relationship between these patterns may allow the computing system 110 to identify the speed and direction of aging for each organ or system being studied. For example, an organ with accelerated methylation changes may indicate faster aging compared to other systems, while consistent methylation patterns across a broader age range may suggest slower aging or optimal biological maintenance.

In some embodiments, the functions may be categorized into four distinct groups based on each function's aging speed calculation. For example, the groups may be reverse, good, average, and need attention. The cutoff values for these categories may be determined by the aging speed and may be adjusted over time to reflect new insights and data. Generally, functions marked as ‘need attention’ require the most focus, as they indicate a high aging speed and elevated system age, suggesting potential areas of concern.

In some embodiments, the computing system 110 may provide a healthy reference aging trajectory section, which presents plots for each of the functions under the system age trajectory category. These plots may be derived from a healthy population across various age groups and illustrate how individuals in good health tend to age. In some embodiments, the trajectories may be categorized into two main types: plateau and accelerating stages. In the plateau stage, such as ages 25-30, the function remains relatively stable over time, indicating that from a system age perspective, healthy individuals in this age range are indistinguishable for this particular function. In contrast, the accelerating stage shows a rapid increase in biological noise, indicating that healthy individuals with this system age for the function are entering a phase of accelerated aging.

The healthy reference aging trajectory provides users with a benchmark for understanding how healthy individuals at the user's system age for a particular function tend to perform and age. This comparison helps users gauge users' own health status against a healthy reference population, providing valuable insights into their aging process. By understanding the typical aging patterns of healthy individuals, healthcare providers and users can better interpret the system age data. This knowledge facilitates personalized health strategies aimed at maintaining or improving function-specific health outcomes.

In some embodiments, the computing system 110 performs a mapping of CpG sites to corresponding transcription factors (TFs) 518 to understand the CpG sites' regulatory impact on biological processes and aging mechanisms. The analysis may involve selection of CpG sites that are known to play critical roles in gene regulation, particularly through the involvement in DNA methylation, which influences gene expression without altering the DNA sequence itself. The computing system 110 may identify how specific CpG methylation changes affect transcriptional activity within cells, especially in organ-specific contexts.

In some embodiments, the computing system 110 may establish the CpG-TF mapping. For example, the computing system 110 may identify CpG sites that are relevant to the organ or system being analyzed. The identified CpG sites are then cross-referenced with known transcription factor binding sites (TFBS) databases. Transcription factors are proteins that bind to specific DNA sequences to regulate gene expression. The relationships between CpG methylation and TF binding are determined by the computing system 110 as data indicating how gene regulation is altered in aging or disease processes. The computing system 110 may use computational models to predict how methylation at specific CpG sites might enhance or inhibit the binding of transcription factors, thereby influencing the downstream expression of genes.

In some embodiments, the computing system 110 may assess the regulatory impact of CpG based on the CpG-TF mapping. For example, the computing system 110 may evaluate whether changes in methylation at the identified CpG sites correlate with altered activity of the associated transcription factors. In some embodiments, the computing system 110 may integrate multi-omic data, such as RNA sequencing and proteomic data, which help to determine the functional consequences of these regulatory changes. For instance, a CpG site located near a gene involved in inflammation may, through methylation changes, reduce the binding efficiency of a transcription factor that normally upregulates inflammatory responses.

By analyzing these interactions, the computing system 110 can provide insights into how aging and other biological processes are regulated at a molecular level. Additionally, this mapping helps identify key transcription factors that may serve as therapeutic targets for modifying age-related gene expression, offering potential interventions to slow or reverse detrimental aging processes in specific organs. The insights gained from this stage can be integrated into the broader functional organ analysis framework.

In some embodiments, the computing system 110 identifies the top aging factors 520. The identification may leverage a combination of multi-omic data and entropy markers. For example, the computing system 110 may use data collected from DNA methylation profiles at CpG sites, particularly those associated with aging processes within specific organs. To determine which factors are most significant, the system analyzes changes in methylation patterns at various CpG sites and correlates these with biological markers, transcription factors, and other regulatory elements known to affect aging.

In some embodiments, the computing system 110 may receive genetic and entropy data from a variety of sources, including DNA methylation, transcriptomic, and proteomic data. Based on the methylation status of CpG sites, the computing system 110 may categorize these CpG sites into organ-specific groups. The computing system 110 may focus on key CpG sites that exhibit significant changes with age to identify the biological pathways most relevant to the aging process. The pathways may involve various factors such as inflammation, oxidative stress, cellular senescence, or mitochondrial dysfunction.

In some embodiments, the computing system 110 may evaluate the functional impact of the pathways by mapping CpG sites to their corresponding transcription factors (TFs). This mapping allows the computing system 110 to identify key regulatory elements involved in gene expression changes that drive aging in different organs. By analyzing the activity of these TFs and their interaction with other biological systems, the computing system 110 may generate a ranked list of factors that play critical roles in influencing aging.

### Example Functional Analysis Process

FIG. 5B is a flowchart depicting an example process 550 for performing a functional analysis of a complex self-regulating system, in accordance with some embodiments. While the process 550 is primarily described as being performed by the computing system 110, in various embodiments the process 550 may also be performed by any suitable computing devices. In some embodiments, one or more steps in the process 550 may be added, deleted, or modified. The process 550 may be preformed using various analyses show in FIG. 5A, including the treatment efficacy measurement 510, the aging assessment 512, the aging determination 514, the aging trajectories and patterns 516, the entropy site to TF mapping 518 and the top aging factors 520.

In some embodiments, the computing system 110 may receive 555 data of a self-regulating system. In some embodiments, the data includes a plurality of entropy markers. In some embodiments, the data may be generated from an assay that determines values of a plurality of entropy markers in a sample of the self-regulating system. Examples of self-regulating systems include organisms such as human subjects. Examples of entropy markers may include any biological markers that may be relevant to the aging process, such as CpG sites, DNA methylation patterns, gene expression levels, telomere length, mitochondrial DNA mutations, histone modifications, microRNA profiles, DNA repair efficiency, protein folding patterns, oxidative stress indicators, lipid peroxidation levels, metabolic rate markers, inflammatory cytokine levels, autophagy-related proteins, cellular senescence markers, reactive oxygen species (ROS) levels, and other suitable markers of dysregulation of RNA, DNA, proteins, or metabolites. Examples of data include biological data such as genomics data or other omics data.

In some embodiments, the computing system 110 may identify 560, from the data, a subset of the entropy markers that are determined to be relevant to a component system. In some embodiments, the entropy markers in the subset are identified based on each entropy marker's degree of variability relative to the component system to determine a correlation of each entropy marker to the component system. Further detail of selecting entropy markers is described in pipeline 400.

In some embodiments, in identifying the subset of entropy markers, the computing system 110 may receive entropy data from a reference population of self-regulating systems across various age groups. The computing system 110 may determine a level of entropy marker variability and apply a model to assess the level of entropy marker variability in the entropy markers against expected variability from the reference population. The computing system 110 may select entropy markers with a level of entropy marker variability above a threshold and group one or more selected entropy markers based on specific organismal functions of the component system.

Examples of component systems include organismal systems such as organs. In some embodiments, the model used to assess the level of entropy marker variability may be a machine learning-based clustering algorithm that groups the entropy markers by similarity in variability patterns. In some embodiments, the entropy markers selected based on the level of entropy marker variability may be further ranked according to predictive power for determining the functional temporal progression rate of the component system.

In some embodiments, the model used to assess the level of entropy marker variability may be a machine learning-based clustering algorithm that groups the entropy markers by similarity in variability patterns. In some embodiments, the entropy markers selected based on the level of entropy marker variability may be further ranked according to predictive power for determining the functional temporal progression rate of the component system.

In some embodiments, the computing system 110 may analyze 565 longitudinal variations in the entropy markers in the subset over a temporal period. In some embodiments, the longitudinal variations comprise alterations of the entropy markers over the temporal period.

In some embodiments, the analysis may include applying a model to identify patterns indicative of accelerated temporal progression. The system may compare observed variations to expected temporal progression trends in a reference population and generate a prediction regarding potential future entropy marker changes. In some embodiments, the analysis of longitudinal variations may involve segmenting temporal data of the entropy markers into distinct phases, determining phase-specific changes in the entropy markers, and evaluating the impact of each phase on the overall temporal progression process of the component system.

In some embodiments, the computing system 110 may generate 570 a functional temporal progression profile for the component system of the self-regulating system based on analyzing the longitudinal variations in the entropy markers. In some embodiments, the functional temporal progression profile comprises an evaluation of an entropy or temporal progression rate for the component system.

Examples of temporal progression profiles include aging profiles. In some embodiments, generating the functional temporal progression profile may include calculating a temporal progression rate score for each entropy marker, aggregating the scores to generate an overall temporal progression rate for the component system, and comparing the overall temporal progression rate to a normative value. In some embodiments, the functional temporal progression profile may further include personalized recommendations for lifestyle modifications based on the entropy markers identified as contributing to accelerated temporal progression.

In some embodiments, the computing system 110 may cause 575 a graphical user interface to display the functional temporal progression profile for the component system of the self-regulating system. In some embodiments, the graphical user interface allows a user to explore different entropy markers and their corresponding contributions to the temporal progression rate of the component system.

In some embodiments, the graphical user interface may include interactive graphical elements that allow users to compare the functional temporal progression profiles of different component systems side-by-side. The interface may also display a timeline feature that shows changes in entropy markers over time and a predictive visualization forecasting future trends of the component system. In some embodiments, the graphical user interface may present a predictive visualization that forecasts a future trend of the component system. In some embodiments, the graphical user interface may issue a visual alert in response to a specific entropy marker indicating accelerated temporal progression of the component system.

### Graphical User Interface Examples

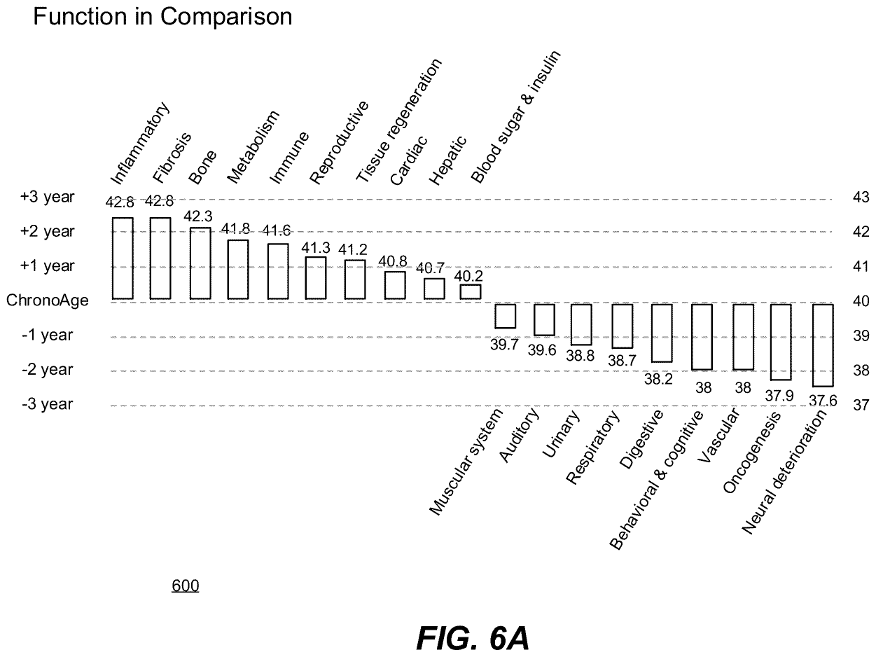

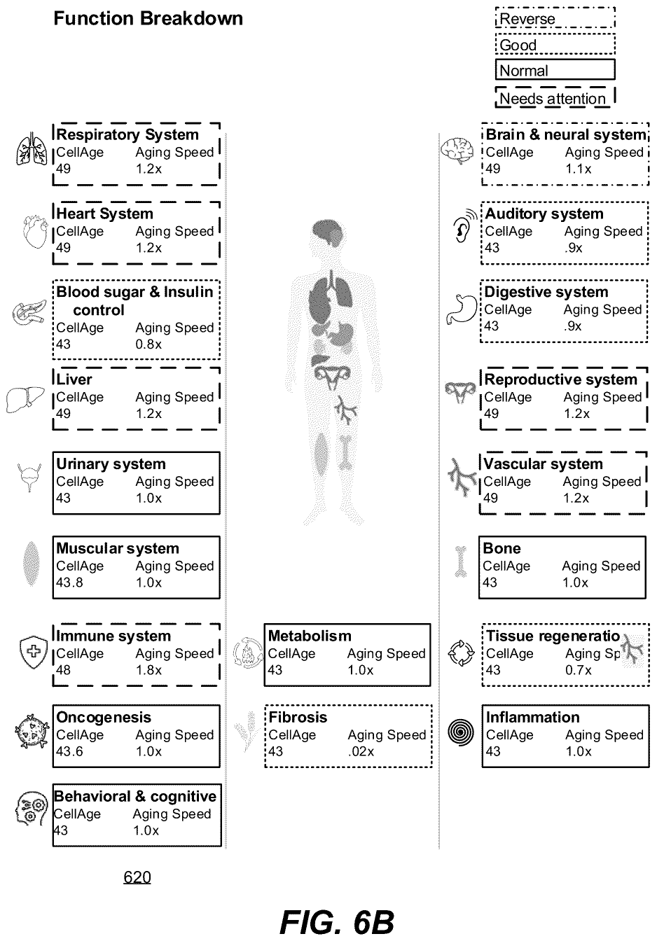

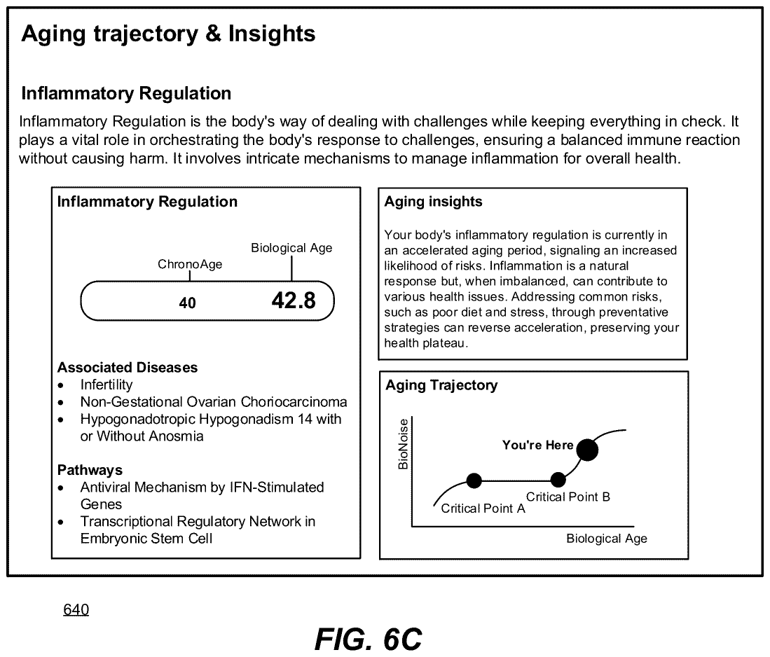

FIG. 6A is a conceptual diagram illustrating an example graphical user interface 600 that displays information of organ-specific ages generated by the computing system 110, in accordance with some embodiments. In some embodiments, the computing system 110 may integrate data from longitudinal studies and large-scale datasets to assess how the identified aging factors change over time. The computing system 110 may determine which aging factors are currently influencing aging and predict which aging factors will have long-term impacts. These aging factors are then prioritized based on statistical significance, clinical relevance, and the strength of their association with various aging-related phenotypes.

In some embodiments, the computing system 110 may generate a report that is related to aging entropy and provide the report in the graphical user interface 600. In some embodiments, the age report may be divided into two primary sections: age analysis and recommendations.

In some embodiments, the graphical user interface 600 may include a central visualization panel that presents a comparative bar chart showing organ-specific ages. The panel may be referred to as an organ age comparison panel. This panel uses bars to display the relative biological age of each organ, with the length and direction of each bar indicating whether the organ is aging faster or slower than the user's chronological age. The bars may be color-coded or use different patterns to signify different organismal systems or levels of deviation. Each bar represents a different organ or biological function, with positive and negative deviations from the chronological age indicating whether the organ is aging faster or slower than expected. In some embodiments, the graphical user interface 600 may include a data summary. The data summary provides numerical details and statistical insights, such as the exact values of each organ's biological age, standard deviations, and comparative percentages relative to the chronological age. This detailed view allows users to obtain precise data for further analysis or reporting.

The graphical user interface 600 may also include data Axis and annotations. For example, the graphical user interface 600 may include a labeled vertical axis that provides age values, allowing users to understand the exact age differences between organ functions. This is paired with a horizontal line that represents the baseline of the chronological age. Each bar may be labeled with its corresponding organismal system. The graphical user interface 600 may include a legend that uses different colors or patterns to distinguish between organ groups or highlight significant deviations.

In some embodiments, the graphical user interface 600 might support interactive features, such as tooltips or click-to-view details, allowing users to explore the underlying data for each organ. This feature enables a more in-depth analysis of aging trends and treatment impacts. For example, the graphical user interface 600 may include an interactive control that allows users to filter or adjust the displayed data. Users can select specific organismal systems, time intervals, or treatment phases to customize the display, enabling a focused analysis of particular aspects of the aging process. The control may also include options for exporting data, such as downloading graphs or reports in various formats.

FIG. 6B is a conceptual diagram illustrating an example graphical user interface 620 that displays information of organ-specific ages generated by the computing system 110, in accordance with some embodiments. In some embodiments, the graphical user interface 620 may include a centralized organ visualization panel featuring a human body diagram, which provides the location and status of various organs. This diagram may be surrounded by panels that display detailed organ-specific data such as cell age and aging speed, providing a comprehensive overview of each organ's status. The diagram visually may represent the aging status of each organ, enabling users to quickly identify which organs require attention.

In some embodiments, the graphical user interface 620 may include detailed data panels adjacent to the human body diagram. These panels may list individual organs, each accompanied by metrics such as “CellAge” and “Aging Speed,” which quantify the biological age of the organ and the rate at which the organ is aging. The data panels allow for a granular understanding of how different organs age relative to each other, offering valuable insights into the overall health and aging patterns of the subject. In some embodiments, the graphical user interface 620 may include a status indicator panel, which classifies organs into different aging categories such as “Normal,” “Needs Attention,” “Good,” or “Reverse.” These categories may be color-coded or use specific icons to enhance clarity. This panel allows users to quickly assess which organs are aging well and which may require further intervention or monitoring.

In some embodiments, a purpose of the system age breakdown is to provide a clear visual representation and understanding of the performance of each bodily function. The breakdown allows for targeted interventions and monitoring to maintain or improve overall health.

In some embodiments, the graphical user interface 620 may include interactive controls that allow users to adjust which metrics are displayed, filter by specific time points, or focus on particular organs. These controls enable personalized analysis, making it easier to track progress over time or the impact of specific treatments on organ health.

FIG. 6C is a conceptual diagram illustrating an example graphical user interface 640 that displays information aging trajectory and insights that are generated by the computing system 110, in accordance with some embodiments. In some embodiments, the graphical user interface 640 may include an overview panel that highlights key metrics related to a specific biological function, such as inflammatory regulation. This panel displays both the chronological age and the biological age of the function, allowing users to assess how it deviates from expected aging patterns. This comparison provides a quick snapshot of whether the biological process is aging normally or experiencing acceleration or deceleration.

In some embodiments, the graphical user interface 640 may include an aging insights panel that offers personalized interpretations of the data. This panel provides context regarding the current aging status and its implications for overall health, identifying risks associated with accelerated aging in the monitored biological function. The graphical user interface 640 may suggest lifestyle changes or interventions to mitigate these risks, offering practical recommendations to slow down or reverse undesirable aging trends.

In some embodiments, the graphical user interface 640 may include a detailed information panel that lists associated diseases, biological pathways, and other relevant details related to the specific function being analyzed. This section helps users understand the broader context of the biological process, linking the aging status to potential health conditions or genetic pathways that might be impacted.

In some embodiments, the graphical user interface 640 may feature an aging trajectory panel, which visualizes the progression of aging over time. This panel may include a graph plotting critical points that represent shifts in the aging process, allowing users to track changes and identify important moments where aging has accelerated or slowed. This visual representation aids users in understanding their current position within the aging curve and highlights potential opportunities for intervention to maintain or improve biological function. The graph generated may be based on continuous collection of the biological samples of the users to determine a trajectory.

### Personalized Epigenetic Based Recommendation System

FIG. 7 is a flowchart depicting a process 700 for generating personalized epigenetic based recommendation, in accordance with some embodiments. The process 700 may be an example of the stage 330 described in FIG. 3. The process 700 may be performed by one or more components of the computing system 110, such as the epigenetic recommendation generator 250. While the process 700 is primarily described as being performed by the computing system 110, in various embodiments the process 700 may also be performed by any suitable computing devices. In some embodiments, one or more steps in the process 700 may be added, deleted, or modified. In some embodiments, the steps in the process 700 may be carried out in a different order that is illustrated in FIG. 7. In some embodiments, computing system 110 may rely on entropy markers of the user. The entropy markers can be markers of biological entropy such as dysregulation of CpG sites, RNA, DNA, proteins metabolites. In FIG. 7, entropy sites such as CpG sites are used as examples, but in various embodiments the entropy markers can be any other suitable entropy markers

In some embodiments, the computing system 110 may collect 710 data from relevant research papers. For example, the computing system 110 may scrape papers from a wide array of databases, research journals, and repositories that publish scientific studies on epigenetics, DNA methylation, histone modification, chromatin remodeling, transcriptomics, proteomics, non-coding RNA regulation, cellular senescence, gene expression regulation, aging biomarkers, environmental epigenomics, and nutrigenomics, and related fields. This paper collection process involves may include using web crawlers, APIs, and other data retrieval tools to gather research articles.

The collected data may include detailed studies about CpG sites, organ function, and age-specific changes in DNA methylation. The computing system 110 may filter the papers to ensure that the collected data is relevant to the analysis criteria. The filtering may exclude papers that lack sufficient statistical analysis, do not pertain to CpG methylation, or are based on outdated methodologies. In some embodiments, the computing system 110 may include papers that present substantial evidence from wide-ranging age groups, such as those aged 20 to 90 years, to ensure the data is comprehensive.

In some embodiments, the computing system 110 may parse 712 data from the collected research papers. After gathering the raw data of the research papers, the computing system 110 organizes and structures the information to make the data usable for further analysis. This parsing process involves breaking down the text, figures, and tables from the research papers into distinct, analyzable components. The computing system 110 applies natural language processing (NLP) techniques to interpret the text-based data, extracting key elements such as statistical values, CpG site details, methylation patterns, and sample demographics. The computing system 110 may also turn the data into structured data such as by organizing the data by indices, columns and rows, keywords, linked lists, knowledge ontology and other data processing techniques.

In some embodiments, the computing system 110 may identify and tag important sections of each paper, such as experimental results, statistical models, and significant findings, particularly those related to DNA methylation and its implications on aging or organ-specific functions. Additionally, the computing system 110 may extract numerical data from tables, including methylation changes over time, CpG site variances, and age-based methylation levels. For graphical data, such as charts or heatmaps, the computing system 110 may use image recognition tools to convert the visual information into structured datasets. The computing system 110 stores the extracted data in a structured format, such as a database or matrix, for the next phase of analysis.

In some embodiments, the computing system 110 may identify 714 relationships from the parsed data. After structuring the extracted information, the computing system 110 analyzes the data to detect relationships between various factors, specifically focusing on the correlation between CpG methylation patterns and biological aging markers or organ-specific functions.

The computing system 110 employs statistical and machine learning models to uncover significant patterns in the data to identify CpG sites that are either stable or exhibit significant changes with aging.

The system evaluates the parsed data against a set of predefined criteria, such as methylation variability across different age groups, organ-specific methylation changes, or associations between CpG sites and specific biological functions like inflammation or fibrosis. For example, the system may examine methylation patterns from individuals aged 20 to 90 years and isolate relationships that exhibit meaningful shifts in methylation states as the age increases. The identified relationships may pertain to key CpG sites that are either consistent across various samples or that demonstrate significant epigenetic drift over time. The identified relationships may be used to build a framework to predict biological age or assess organ-specific health conditions. The computing system 110 may identify robust and statistically supported relationships that are carried forward for further statistical significance testing.

In some embodiments, the computing system 110 may determine 716 whether an identified relationship is statistically significant. In response to the computing system 110 detecting a potential relationship between CpG methylation patterns and aging or organ-specific markers, the computing system 110 evaluates the relationship to ensure the relationship meets a predefined level of statistical significance. This process may involve applying statistical tests, such as p-value analysis or confidence intervals, to confirm whether the observed correlations are not due to random chance.

In some embodiments, the computing system 110 may use methods such as regression analysis, log-linear variance models, or chi-square tests, depending on the nature of the data, to assess the strength of the relation. For example, if the computing system 110 identifies a particular CpG site where methylation increases with age, the computing system 110 will calculate the variance across the entire dataset and determine if the correlation holds across different age groups and sample sizes. The computing system 110 may determine whether the relationship is consistent and meaningful across different age groups and sample sizes.

In some embodiments, the computing system 110 may also consider factors such as the effect size, variability in the data, and potential confounders that could affect the validity of the relation. In cases where the relationship does not meet the statistical threshold, the computing system 110 may either discard the identified relationship or flag identified relationship for further investigation, such as by combining the identified relationship with other weakly significant relationships to identify broader patterns.

In some embodiments, the computing system 110 may generate 718 score that is based on statistical analysis for the identified relation. In response to the computing system 110 verifying the statistical significance of a relationship between CpG methylation patterns and aging or organ-specific functions, the computing system 110 proceeds to evaluate whether the identified relationship should be included in the scoring phase. This evaluation process ensures that only meaningful and reliable relationships are considered further in the analysis, avoiding spurious correlations that might skew the results. In some embodiments, the system may use predefined thresholds and criteria to decide if a relationship should proceed to scoring. These criteria may include the magnitude of the correlation, the robustness of the statistical significance (such as p-value thresholds), and the consistency of the relationship across multiple datasets. Relationships with high effect sizes and strong statistical backing are prioritized for scoring, while weaker relationships may be excluded or subjected to additional scrutiny before being considered for scoring. Based on the statistical significance, computing system 110 may generate a first score that is based on the statistical test.

In some embodiments, the computing system 110 may check 720 the citation counts of an identified relationship to determine the relation's prevalence and significance in scientific literature. After identifying a relation, the computing system 110 evaluates how often the relationship has been mentioned or referenced across various studies. The citation count indicates the extent to which a particular relationship has been validated, discussed, or explored by other researchers, serving as a measure of the relation's impact within the scientific community.

The computing system 110 retrieves citation information from sources such as Google Scholar, PubMed, or other citation index services, focusing on the frequency with which a relationship appears across multiple papers. Relationships with higher citation counts may be considered more established and may receive greater weight in the scoring process, as their presence across numerous studies suggests robust validation. Conversely, relationships with lower citation counts may be assigned less influence unless other corroborating metrics, such as statistical significance, support their relevance.

In some embodiments, the computing system 110 may normalize 722 the citation counts of an identified relationship to allow various identified relationships to be compared quantitively. In some embodiments, the computing system 110 may normalize 722 the citation count and calculate a percentile score to standardize the assessment of the identified relation. Normalization may be used to account for varying publication times, research fields, and the natural variance in citation accumulation across different studies.

The computing system 110 may apply statistical adjustments to balance disparities among the identified relations, allowing for a more accurate comparison of relationships regardless of the time of discovery of the relations. The normalization may involve techniques such as calculating a citation rate over time or adjusting counts to percentile rankings among similar studies. The computing system 110 normalizes the scoring such that a newly identified but potentially significant relationship is not unfairly undervalued compared to older, well-established relations.

In some embodiments, the computing system 110 may calculate a percentile score for each identified relationship to assess the relation's relative standing among all analyzed relationships using the normalized citation counts. This calculation may involve ranking the citation count of the relationship against the citation counts of other identified relationships within a dataset. The computing system 110 may determine the percentile rank by calculating the proportion of relationships with equal or lower citation counts. This percentile score allows the computing system 110 to compare relationships of varying citation counts and significance, providing a standardized metric that integrates both the influence of a relationship and the distribution of citations across the dataset. The percentile score may be a second score in addition to the first score that is determined from statistical analysis.

In some embodiments, the computing system 110 may evaluate 724 the sample size associated with each identified relationship to assess the robustness and reliability of the underlying data. For example, the computing system 110 may analyze the number of participants or data points that were used in the studies supporting each identified relation. A larger sample size generally indicates a higher level of statistical power, reducing the likelihood of random variations or anomalies affecting the results.

The system considers the sample size as a factor when determining the strength of a relation, especially when combined with other metrics such as statistical significance and citation counts. Relationships derived from studies with small sample sizes may be weighted lower, as they might be more susceptible to bias or lack generalizability. Conversely, relationships supported by larger sample sizes are treated with greater confidence, reflecting the increased reliability of their findings. This sample size evaluation helps ensure that the overall scoring process gives appropriate consideration to the methodological rigor behind each relation. The computing system 110 may generate 726 a third score of an identified relationship based on the sample size.

In some embodiments, the computing system 110 may combine 728 various heuristics to calculate an overall score for each identified relation. After gathering data, normalizing citation counts, and scoring based on sample sizes, the system applies multiple heuristic methods to derive a comprehensive score for each identified relation. These heuristics may include determining the statistical significance of the identified relations, the robustness of sample sizes, and the reliability of citation counts. The computing system 110 also considers other factors, such as the diversity of sample populations, the time span of data collection, and any potential biases that could affect the data. For instance, the computing system 110 may account for the impact of aging across different organismal systems and analyze how specific treatments, such as vitamin D intake, affect various biological markers like inflammation or fibrosis.

In some embodiments, the computing system 110 may use multiple heuristics and the various scores generated in previous steps, such as steps 718, 722, and 726, may be weighted based on the relative importance to the final outcome. The computing system 110 may integrate these weighted scores into a single, overall score that represents the reliability and relevance of each identified relation. This overall score provides a clear metric by which the computing system 110 can evaluate and rank multiple relations, preparing them for the final ranking stage.

In some embodiments, the computing system 110 may update 730 the relationship score based on the cumulative data from previous steps, including citation counts, sample size, statistical significance, normalized scores. The updated relationship score may be the final score corresponding to the identified relation. After the computing system 110 has analyzed and processed these metrics for each identified relation, the computing system 110 integrates the results to revise and finalize the score associated with each relation. In some embodiments, the relationship score may represent the strength and reliability of the identified correlation between a particular CpG site and a biological function or aging marker.

In some embodiments, the computing system 110 may rank 732 all relationships based on the relations' overall scores. After calculating the combined heuristic scores for each relation, the computing system 110 organizes these relationships in a ranked order to prioritize the most statistically significant, well-supported findings. The ranking may be used for subsequent decision-making. For example, the ranking determines which relationships have the highest confidence levels and are more relevant for downstream applications such as personalized health recommendations or treatment efficacy evaluations. The computing system 110 may store the ranking for use in generating personalized epigenetic recommendations, allowing computing system 110 to focus on the top-ranked, most impactful relationships for further investigation or intervention.

In some embodiments, the computing system 110 may generate 734 personalized recommendations based on the ranked relations. Based on the ranking of relevant relations, the computing system 110 uses top-ranking findings to formulate tailored health recommendations for users. These recommendations are derived from the collected entropy data of the users, including DNA methylation patterns at specific CpG sites across a period of time, and are further refined by integrating the biological significance of the ranked relations.

In some embodiments, the computing system 110 may use the ranked relationships to identify actionable insights into a user's health, such as the impact of certain nutrients, lifestyle changes, or medical interventions on aging markers and organ function. For example, if a high-ranking relationship suggests that increased vitamin D intake is correlated with improved bone health or reduced biological aging, the computing system 110 may recommend dietary modifications or supplementation to slow down the aging process in that specific organismal system.

The personalized recommendations may be designed to address various aspects of the user's health, including nutrition, lifestyle changes, therapies, and medication. The computing system 110 may further integrate external factors, such as environmental and genetic data, to provide a holistic set of recommendations. Each recommendation is tailored to the specific health profile of the individual, based on the ranked relations, ensuring that the advice is both evidence-based and highly personalized for optimal efficacy.

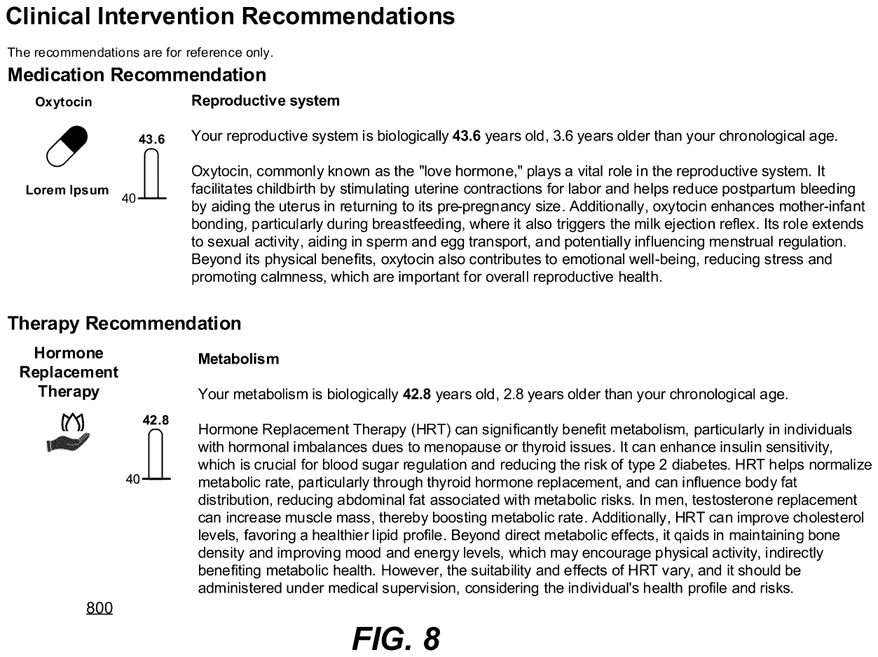

FIG. 8 illustrates an example graphical user interface (GUI) 800, which displays personalized epigenetic recommendations generated by the computing system 110, in accordance with some embodiments. The GUI 800 may be part of the user interface 134. The GUI 800 may be structured to present various types of personalized health interventions based on a user's epigenetic analysis results. The GUI 800 features a panel that highlights different categories of recommendations, such as medication and therapy recommendations. The GUI's design allows for the integration of multiple recommendation types, including potential lifestyle or dietary recommendations, in addition to the example medication and therapy suggestions illustrated in FIG. 8.

In some embodiments, each recommendation may be organ-specific. The GUI 800 may provide the displayed interventions to target specific organismal systems based on their biological age relative to the user's chronological age. For instance, separate sections in the GUI 800 may present information about the biological age of different organs, such as the reproductive system or metabolism as shown FIG. 8. Each recommendation section includes a graphical element, such as a pill or medical icon, accompanied by text detailing the recommended intervention. Organismal systems may be organ systems, cellular networks, molecular pathways, ecological interactions, tissue systems, or any suitable components or component groups in a self-regulating system such an organism.

In some embodiments, the GUI 800 may feature an area that displays the biological age of the analyzed organismal system. The visual indicator shows the calculated biological age alongside the user's chronological age, providing a comparison that helps users understand how their organismal system is aging. The area is designed to help users quickly interpret the analysis results and see where targeted interventions might be beneficial. The overall layout is intended to provide a user-friendly, organized view of actionable health insights based on their epigenetic profile.

### Component Specific Analysis Process

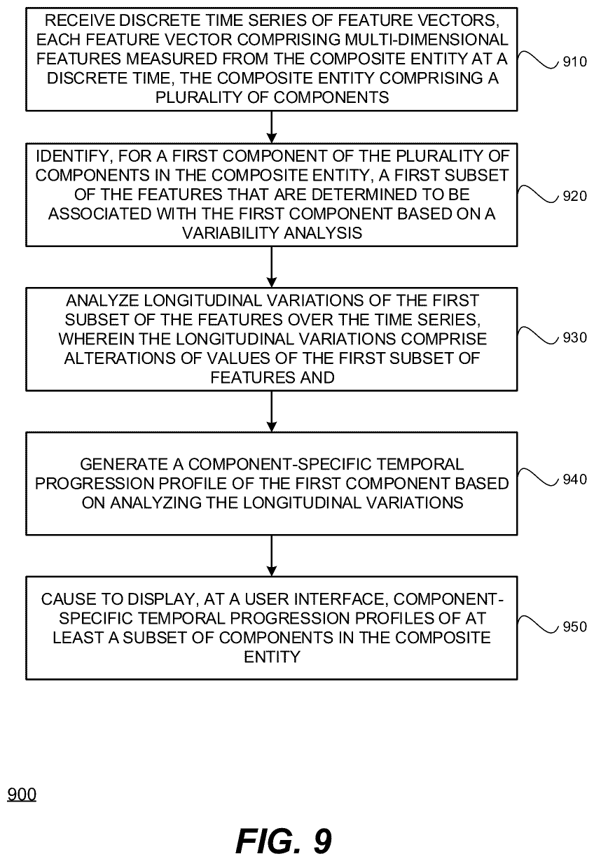

FIG. 9 is a flowchart depicting an example process 900 for performing a component specific analysis, in accordance with some embodiments. While the process 900 is primarily described as being performed by the computing system 110, in various embodiments the process 900 may also be performed by any suitable computing devices. In some embodiments, one or more steps in the process 900 may be added, deleted, or modified. The process 900 may be performed using various analyses discussed in this disclosure.

In some embodiments, the computing system 110 may receive 910 discrete time series of feature vectors. Each feature vector comprises multi-dimensional features measured from the composite entity at a discrete time. The composite entity, in one example, may include a machine that comprises a plurality of interrelated components such as gears, sensors, actuators, and control units in an industrial maintenance scheme. In other embodiments, the composite entity may correspond to a biological subject, such as the body of an individual with multiple organs and functional units, as described in the rest of the specification. The time series data may represent periodic measurements taken from each component to monitor its operational status or, in a biological context, longitudinal sample collections capturing biological markers over time. In a machinery context, a feature vector comprising multi-dimensional features might include measurements such as temperature, vibration frequency, rotational speed, energy consumption, and pressure recorded from different components (e.g., motors, bearings, or actuators) of a machine over time. Each feature represents a distinct attribute relevant to the machine's operational status and maintenance needs. In a biological context, a feature vector comprising multi-dimensional features can include values such as DNA methylation levels at specific CpG sites, gene expression levels, protein concentrations, metabolite levels, and other biological markers measured from a tissue or organ sample. Each feature reflects a particular reading of a site that is generated by one or more assys.

In some embodiments, the computing system 110 may identify 920, for a first component of the plurality of components in the composite entity, a first subset of features that are determined to be associated with the first component based on a variability analysis. For example, in a machinery context, the first component may be a particular actuator, and the features could be vibration frequency, temperature, and energy consumption metrics. The variability analysis identifies which features show the most significant changes specific to that actuator, differentiating them from features relevant to other components, such as gears or sensors. In a biological setting, the component may be an organ, and the features may be entropy markers (such as CpG methylation values) selected using organ-specific marker analysis processes discussed in pipeline 310 and FIG. 4 of the specification. To identify the first subset of features, the computing system 110 may evaluate each feature's degree of variability relative to the first component to determine a correlation of each feature to the component. Further, the system may receive indicator data from a reference population of composite entities across various time ranges, determine a level of feature variability, apply a model (which may include machine learning-based clustering algorithms that group features by similarity in variability patterns) to assess feature variability against expected variability from the reference population, select features with a variability above threshold, and group one or more selected features based on component-specific functions within the composite entity. Features selected based on variability may be ranked according to their predictive power for determining the temporal progression rate of the first component.

In some embodiments, the computing system 110 may analyze 930 longitudinal variations of the first subset of the features over the time series, wherein the longitudinal variations comprise alterations of values of the first subset of features. For instance, in a machine, this might involve tracking how a temperature sensor's readings for an actuator fluctuate across maintenance cycles, identifying periods of accelerated wear or abnormal operation. In biological organisms, this parallels tracking changes in methylation levels of selected entropy markers for an organ over time, as described in the aging trajectory and longitudinal variation analyses in the specification (see, e.g., step 320 and FIG. 5A). The system may apply models to identify patterns indicative of accelerated progression in the component, compare observed variations to expected trends in a reference population, and generate predictions regarding potential future changes in feature values. Additionally, the system may segment temporal data into distinct phases, determine phase-specific changes, and evaluate the impact of each phase on the overall progression process of the component.

In some embodiments, the computing system 110 may generate 940 a component-specific temporal progression profile of the first component based on analyzing the longitudinal variations described above. For example, in a non-biological setting, such a profile may detail the maintenance and operational progression of an engine or actuator within a machine, showing metrics like wear rate, efficiency losses, or other performance trends over time. In a biological context referenced elsewhere in the specification, the progression profile may correspond to the organ-specific aging trajectory, indicating the biological age or health state of a particular organ, as discussed in relation to FIG. 5A and the functional organ analysis stages. The generated profile may include quantitative assessments such as the rate of feature variability, summaries of distinct phases identified in the temporal data, and predictions about future component status. The process of generating the component-specific profile may use statistical models, aggregate progression scores, and normative comparisons, similar to methods described in the functional age predictor and personalized recommendation pipeline detailed in the specification.

In some embodiments, the computing system 110 may cause 950 the user interface to display the component-specific temporal progression profiles of at least a subset of components in the composite entity. This display may include interactive charts, dashboards, or comparative panels that allow the user to review and analyze the temporal progression data for various components. For example, in a machine maintenance platform, the user interface may show side-by-side profiles for different parts of the machine, highlighting those requiring attention or maintenance. In biological applications, such as those described in FIGS. 6A, 6B, and 6C, the graphical user interface may present organ-specific ages, health insights, and aging trajectories, enabling users to explore individual or comparative progression data. Additional features may include timeline visualization, predictive trends, alerts for accelerated progression, and interactive tools for examining feature contributions, just as the application and GUI elements are implemented in the rest of the disclosure.

### Example Machine Learning Model

In various embodiments, a wide variety of machine learning techniques may be used, such as for the machine learning models 235. Examples include different forms of supervised learning, unsupervised learning, and semi-supervised learning, such as decision trees, support vector machines (SVMs), regression, Bayesian networks, and genetic algorithms. Deep learning techniques such as neural networks, including convolutional neural networks (CNN), recurrent neural networks (RNN), long short-term memory networks (LSTM), transformers, and linear recurrent neural networks like Mamba may also be used. For example, various CpG site identification tasks, methylation pattern analysis, and may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to identify changes in DNA methylation related to aging, the training samples may be DNA methylation profiles from different age groups. The labels for each training sample may be binary or multi-class. In training a machine learning model for detecting treatment efficacy, the training labels may include a positive label that indicates successful reduction in methylation changes and a negative label that indicates no significant change in methylation patterns.

By way of example, the training set may include multiple past records of epigenetic profiles with known outcomes. Each training sample in the training set may correspond to a past biological sample, and the corresponding outcome may serve as the label for the sample. A training sample may be represented as a feature vector that includes multiple dimensions. Each dimension may include data of a feature, which may be a quantized value of an attribute that describes the methylation status of specific CpG sites. For example, in a machine learning model that is used to evaluate aging rates, the features in a feature vector may include CpG site methylation levels, organ-specific methylation markers, genetic factors, etc. In various embodiments, certain pre-processing techniques may be used to normalize the values in different dimensions of the feature vector.

In some embodiments, an unsupervised learning technique may be used. The training samples used for an unsupervised model may also be represented by feature vectors but may not be labeled. Various unsupervised learning techniques such as clustering may be used in determining similarities among the feature vectors, thereby categorizing the training samples into different clusters. In some cases, the training may be semi-supervised, with a training set having a mix of labeled samples and unlabeled samples.

A machine learning model may be associated with an objective function that generates a metric value describing the objective goal of the training process. The training process may be intended to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in predicting organ-specific aging trajectories, the objective function may correspond to minimizing the difference between predicted and actual biological ages. In various embodiments, the error rate may be measured as cross-entropy loss, L1 loss (e.g., the sum of absolute differences between the predicted values and the actual value), or L2 loss (e.g., the sum of squared distances).

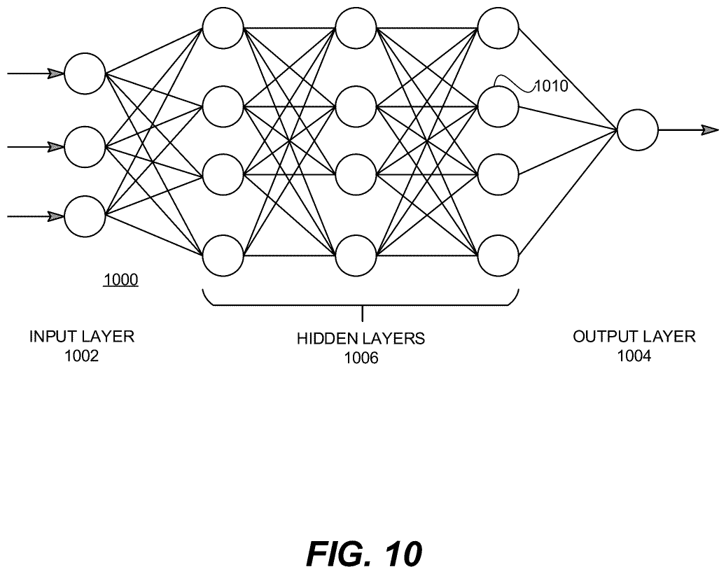

Referring to FIG. 10, a structure of an example neural network is illustrated, in accordance with some embodiments. The neural network 1000 may receive an input and generate an output. The input may be the feature vector of a training sample in the training process and the feature vector of an actual case when the neural network is making an inference. The output may be prediction, classification, or another determination performed by the neural network. The neural network 1000 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layers and pooling layers may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 1000 may vary in different embodiments. In various embodiments, a neural network 1000 includes one or more layers 1002, 1004, and 1006, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 1010, kernels and/or coefficients. Training of a neural network, such as the NN 1000, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

In some embodiments, the training samples described above may be refined and continue to re-train the model, improving the model's ability to perform the inference tasks. For example, a computing device may receive a training set that includes DNA methylation profiles from various biological samples across different age groups and treatment conditions. Each training sample in the training set may be assigned with labels indicating the biological age of the sample or the efficacy of a treatment in altering the methylation patterns. The computing device, in a forward propagation, may use the machine learning model to generate predicted biological age or treatment outcomes. The computing device may compare the predicted biological age with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagation may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent, such as stochastic gradient descent (SGD), to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing epigenetic-based predictions of aging speed and treatment outcomes or another suitable task for which the model is trained.

In various embodiments, the training process may include periodically retraining the machine learning model. The periodic retraining may include obtaining an additional set of training data, such as through other sources like new biological samples from ongoing treatments or new subjects and by using the trained machine learning model to generate additional samples. The additional set of training data may include updated methylation profiles, newly identified CpG sites, or refined genetic information. The process may also include applying the additional set of training data to the machine learning model and adjusting parameters of the machine learning model based on the applying of the additional set of training data. The additional set of training data may include any features and/or characteristics that are mentioned above, helping the model remain up to date with evolving biological insights and increasing its predictive accuracy for different treatment and aging scenarios.

In some embodiments, the AI model developed for epigenetic analysis may leverage a combination of longitudinal data and real-time analysis capabilities to provide dynamic insights into the aging process. For example, the machine learning model may continuously integrate new methylation data obtained from periodic biological samples, updating predictions of biological age trajectories. This continuous learning approach ensures that the model remains adaptive to changes in a subject's lifestyle, environment, or treatment regimen, enabling a personalized aging analysis.

The AI system can also include multi-omics integration, where data from RNA sequencing, proteomics, and other genomic information is combined with DNA methylation data. This integration allows the model to consider a broader spectrum of biological changes, offering a more holistic view of aging and treatment efficacy. For instance, the AI may correlate changes in CpG methylation with transcription factor activity and protein expression levels, identifying how gene regulation shifts with age or in response to specific interventions. By connecting these different layers of biological data, the system provides more accurate predictions and identifies potential biological pathways for targeted interventions.

In some embodiments, the objective function of the machine learning model may be tailored for minimizing the difference between observed and predicted methylation changes over time, particularly focusing on sites known to be sensitive to age-related changes. For example, the objective function may be designed to minimize the error between predicted methylation levels and actual levels in specific age-related CpG sites.

Additionally, the AI system may include a predictive feedback loop, where the results of treatment predictions are used to adjust future predictions. For example, if the model identifies a significant reduction in methylation levels in response to a dietary intervention, the model may adjust its prediction to better anticipate the effects of similar interventions on other subjects. This feedback mechanism enhances the accuracy and reliability of the model's predictions, ensuring that it can adapt to various treatment modalities over time.

The trained AI model may then be deployed for various use cases, such as tracking aging progression in clinical studies, evaluating the impact of new treatments, or offering personalized health insights in consumer wellness applications. The AI model's ability to integrate diverse data sources and update its predictions based on new information makes it a powerful tool for advancing personalized medicine and preventative health strategies. By providing precise and adaptive analyses of how aging progresses at a molecular level, the AI system may help individuals and healthcare providers make informed decisions aimed at slowing down or reversing age-related changes.

### Computing Machine Architecture

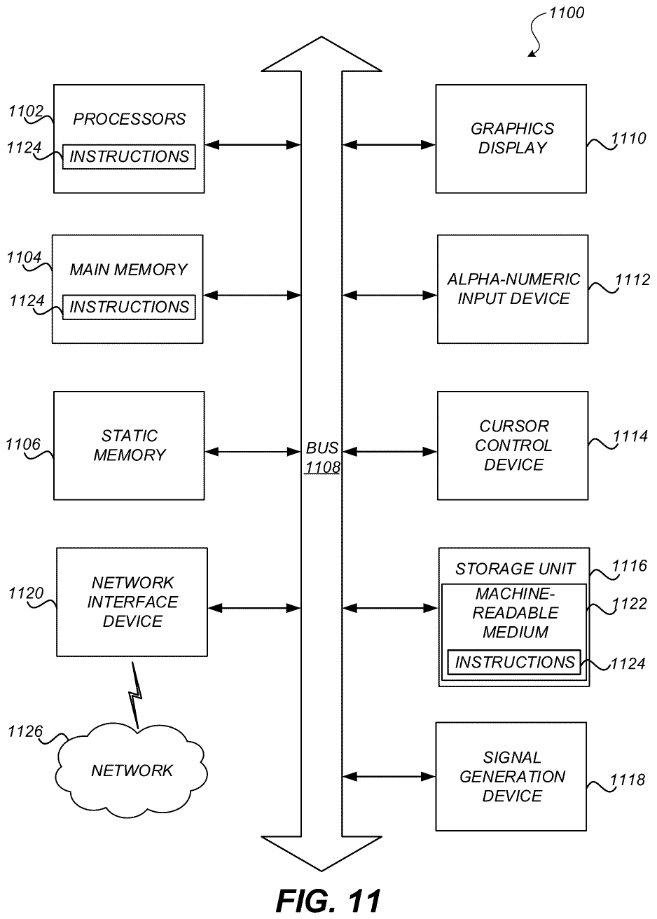

FIG. 11 is a block diagram illustrating components of an example computing machine that is capable of reading instructions from a computer-readable medium and executing them in a processor (or controller). A computer described herein may include a single computing machine shown in FIG. 11, a virtual machine, a distributed computing system that includes multiple nodes of computing machines shown in FIG. 11, or any other suitable arrangement of computing devices.

By way of example, FIG. 11 shows a diagrammatic representation of a computing machine in the example form of a computer system 1100 within which instructions 1124 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 11 may correspond to any software, hardware, or combined components shown in FIGS. 1 and 2, including but not limited to, the computing system 110, point-of-care device 120, the sample analyzer 125, the client device 130, and various engines, interfaces, terminals, and machines shown in FIG. 2. While FIG. 11 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IOT) device, a switch or bridge, or any machine capable of executing instructions 1124 that specify actions to be taken by that machine. Further, while only a single machine is illustrated, the terms “machine” and “computer” may also be taken to include any collection of machines that individually or jointly execute instructions 1124 to perform any one or more of the methodologies discussed herein.

The example computer system 1100 includes one or more processors 1102 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1100 may also include a memory 1104 that stores computer code including instructions 1124 that may cause the processors 1102 to perform certain actions when the instructions are executed, directly or indirectly by the processors 1102. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 1102 and reduce the space required for the memory 1104. For example, the database processing techniques and machine learning methods described herein reduce the complexity of the computation of the processors 1102 by applying one or more novel techniques that simplify the steps in training, reaching convergence, and generating results of the processors 1102. The algorithms described herein also reduce the size of the models and datasets to reduce the storage space requirement for memory 1104.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 1100 may include a main memory 1104, and a static memory 1106, which are configured to communicate with each other via a bus 1108. The computer system 1100 may further include a graphics display unit 1110 (e.g., a plasma display panel (PDP), a liquid crystal display (LCD), a projector, or a cathode ray tube (CRT)). The graphics display unit 1110, controlled by the processor 1102, displays a graphical user interface (GUI) to display one or more results and data generated by the processes described herein. The computer system 1100 may also include an alphanumeric input device 1112 (e.g., a keyboard), a cursor control device 1114 (e.g., a mouse, a trackball, a joystick, a motion sensor, or other pointing instruments), a storage unit 1116 (a hard drive, a solid-state drive, a hybrid drive, a memory disk, etc.), a signal generation device 1118 (e.g., a speaker), and a network interface device 1120, which also are configured to communicate via the bus 1108.

The storage unit 1116 includes a computer-readable medium 1122 on which are stored instructions 1124 embodying any one or more of the methodologies or functions described herein. The instructions 1124 may also reside, completely or at least partially, within the main memory 1104 or within the processor 1102 (e.g., within a processor's cache memory) during execution thereof by the computer system 1100, the main memory 1104 and the processor 1102 also constituting computer-readable media. The instructions 1124 may be transmitted or received over a network 1126 via the network interface device 1120.

While computer-readable medium 1122 is shown in an example embodiment to be a single medium, the term “computer-readable medium” should be taken to include a single medium or multiple media (e.g., a centralized or distributed database, or associated caches and servers) able to store instructions (e.g., instructions 1124). The computer-readable medium may include any medium that is capable of storing instructions (e.g., instructions 1124) for execution by the processors (e.g., processors 1102) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### EXAMPLE EMBODIMENTS

Embodiment 1. A method comprising: providing a recurring sample-collection plan to an individual, the recurring sample-collection plan comprising tracking a systems age for the individual; receiving a plurality of biological samples of the individual as part of the recurring sample-collection plan over a period of time; analyzing a panel of entropy markers in the biological samples; determining a plurality of system age values from the plan of entropy markers over the period of time; and causing to display the system age of the individual as part of the recurring sample-collection plan.

Embodiment 2. A system comprising: a point-of-care device configured to: receive biological samples from an individual periodically; analyze the biological samples to determine values corresponding to a panel of entropy markers; a data store configured to store the values of the panel of entropy markers of the individual over a period of time; and a computing device comprising a processor and memory storing instructions, wherein the instructions, when executed by the processor, cause the processor to: analyze the values of the panel of entropy markers over the period of time; and cause to display a cell age of the individual based on the values of the panel of entropy markers.

Embodiment 3. A method for selecting CpG sites for aging analysis, the method comprising: receiving a plurality of genetic datasets corresponding to a plurality of individuals, the genetic datasets comprising biological ages of the individuals; identifying methylation states of a plurality of CpG sites in the plurality of genetic datasets according to entropy of biological aging process; identifying a subset of CpG sites that are statistically significant to aging based on the methylation states of the plurality of CpG sites and the biological ages of the individuals; and categorizing the subset of CpG sites that are statistically significant to aging into organ-specific groups, each organ-specific group comprising one or more CpG sites that are statistically significant to aging of an organ.

Embodiment 4. A method for conducting an age analysis of organismal systems, the method comprising: assessing a change in methylation states of a panel of CpG sites, the panel of CpG sites corresponding to gene(s) that regulate the maintenance, function and/or repair of an organ; and determining an age trajectory of the organ based on the change in methylation states of such gene(s).

Embodiment 5. A method for providing a personalized epigenetic recommendation, the method comprising: generating a health scoring function that evaluates health status of an individual based on CpG methylation data; generating a recommendation algorithm that parametrizes one or more environmental and lifestyle metrics to model the health scoring function; tracking the environmental and lifestyle, intervention metrics of the individual; and generating the personalized epigenetic recommendation for the individual using the recommendation algorithm and the tracked environmental and lifestyle metrics of the individual.

### ADDITIONAL CONSIDERATIONS

The foregoing description of the embodiments has been presented for the purpose of illustration; it is not intended to be exhaustive or to limit the patent rights to the precise forms disclosed. While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure. Persons skilled in the relevant art can appreciate that many modifications and variations are possible in light of the above disclosure.

The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system for analyzing a composite entity, the system comprising:
a computing system comprising memory and one or more processors, the memory storing code instructions, wherein the code instructions, when executed by the one or more processors, cause the one or more processors to:
receive discrete time series of feature vectors, each feature vector comprising multi-dimensional features measured from the composite entity at a discrete time, the composite entity comprising a plurality of components;
identify, for a first component of the plurality of components in the composite entity, a first subset of the features that are determined to be associated with the first component based on a variability analysis, wherein the first subset of the features corresponding to the first component is different from a second subset of the features corresponding to a second component in the composite entity;
analyze longitudinal variations of the first subset of the features over the time series, wherein the longitudinal variations comprise alterations of values of the first subset of features; and
generate a component-specific temporal progression profile of the first component based on analyzing the longitudinal variations; and
a user interface in communication with computing system, wherein the user interface is configured to display component-specific temporal progression profiles of at least a subset of components in the composite entity.

2. The system of claim 1, wherein the subset of features is identified based on each feature's degree of variability relative to the first component, to determine a correlation of each feature to the component.

3. The system of claim 1, wherein identifying the subset of features comprises:
receiving indicator data from a reference population of composite entities across various time ranges;
determining a level of feature variability;
applying a model to assess the level of feature variability in the features against expected variability from the reference population;
selecting features with a level of variability above a threshold; and
grouping one or more selected features based on component-specific functions within the composite entity.

4. The system of claim 3, wherein the model used to assess the level of feature variability is a machine learning-based clustering algorithm that groups the features by similarity in variability patterns.

5. The system of claim 3, wherein the features selected based on variability are further selected according to predictive power for determining a temporal progression rate of the first component.

6. The system of claim 1, wherein analyzing the longitudinal variations in the subset of features comprises:
applying a model to identify patterns indicative of accelerated component progression;
comparing observed variations to expected progression trajectory in a reference population;
generating a prediction regarding potential future changes in the values of the subset of features.

7. The system of claim 1, wherein the component-specific temporal progression profile includes a quantitative assessment of feature variability over time for the component.

8. The system of claim 1, wherein generating the component-specific temporal progression profile comprises:
calculating a progression rate score for each feature;
aggregating the scores to generate an overall progression rate for the component;
comparing the overall progression rate to normative values.

9. The system of claim 1, wherein the component-specific temporal progression profile further includes information related to configuration or operational modifications based on the features identified as contributing to accelerated progression.

10. The system of claim 1, wherein the user interface is configured to allow a user to explore different features and corresponding contributions of those features to a progression rate of a component.

11. The system of claim 1, wherein analyzing the longitudinal variations of the first subset of the features over the time series comprises:
segmenting temporal data of the features into distinct phases;
determining phase-specific changes in the features;
evaluating an impact of each phase on an overall progression process of the component.

12. The system of claim 1, wherein the user interface is further configured to issue a visual alert responsive to a specific feature indicating accelerated progression of the component.

13. The system of claim 1, wherein the user interface is further configured to include interactive graphical elements that allow users to compare component-specific temporal progression profiles of different components within the composite entity side-by-side.

14. The system of claim 1, wherein the user interface is further configured to present a timeline feature that displays changes in the features over time.

15. The system of claim 1, wherein the user interface is further configured to display a predictive visualization that displays a future trend of a specific component.

16. A computer-implemented method for analyzing a composite entity, the computer-implemented method comprising:
receiving discrete time series of feature vectors, each feature vector comprising multi-dimensional features measured from the composite entity at a discrete time, the composite entity comprising a plurality of components;
identifying, for a first component of the plurality of components in the composite entity, a first subset of the features that are determined to be associated with the first component based on a variability analysis, wherein the first subset of the features corresponding to the first component is different from a second subset of the features corresponding to a second component in the composite entity;
analyzing longitudinal variations of the first subset of the features over the time series, wherein the longitudinal variations comprise alterations of values of the first subset of features; and
generating a component-specific temporal progression profile of the first component based on analyzing the longitudinal variations; and
causing to display, at a user interface, component-specific temporal progression profiles of at least a subset of components in the composite entity.

17. The computer-implemented method of claim 16, wherein the subset of features is identified based on each feature's degree of variability relative to the first component, to determine a correlation of each feature to the component.

18. The computer-implemented method of claim 16, wherein identifying the subset of features comprises:
receiving indicator data from a reference population of composite entities across various time ranges;
determining a level of feature variability;
applying a model to assess the level of feature variability in the features against expected variability from the reference population;
selecting features with a level of variability above a threshold; and
grouping one or more selected features based on component-specific functions within the composite entity.

19. The computer-implemented method of claim 16, wherein analyzing the longitudinal variations of the first subset of the features over the time series comprises:
segmenting temporal data of the features into distinct phases;
determining phase-specific changes in the features;
evaluating an impact of each phase on an overall progression process of the component.

20. A non-transitory computer-readable medium configured to store code comprising instructions for analyzing a composite entity, wherein the instructions, when executed by one or more processors, cause the one or more processors to:
receive discrete time series of feature vectors, each feature vector comprising multi-dimensional features measured from the composite entity at a discrete time, the composite entity comprising a plurality of components;
identify, for a first component of the plurality of components in the composite entity, a first subset of the features that are determined to be associated with the first component based on a variability analysis, wherein the first subset of the features corresponding to the first component is different from a second subset of the features corresponding to a second component in the composite entity;
analyze longitudinal variations of the first subset of the features over the time series, wherein the longitudinal variations comprise alterations of values of the first subset of features; and
generate a component-specific temporal progression profile of the first component based on analyzing the longitudinal variations; and
cause to display, at a user interface, component-specific temporal progression profiles of at least a subset of components in the composite entity.
